(19) United States
(12) Patent Application Publication
(10) Pub. No.: US 2025/0125879 A1
(43) Pub. Date: Apr. 17, 2025

(54) RECEPTION CONTROL DEVICE, RECEPTION CONTROL METHOD, AND RECORDING MEDIUM

(71) Applicant: NEC Corporation, Minato-ku, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Minato-ku, Tokyo (JP)

(21) Appl. No.: 18/688,000

(22) PCT Filed: Sep. 15, 2021
(86) PCT No.: PCT/JP2021/033944

§ 371 Date: Feb. 29, 2024

(51) Int. Cl. H04B 10/69

(52) U.S. Cl. CPC H04B 10/69

(57) ABSTRACT

A reception control device that includes a first processing circuit that includes a switching circuit including a switch connected to light receiving elements, a selection switch arranged for each group to which the light receiving elements are allocated, and a changeover switch that switches an output destination of the selection switch for each group, and an amplifier circuit including amplifiers connected to an output of the switching circuit, a selector that is connected to an output of the first processing circuit, second processing circuits that is arranged downstream of the selector and decodes a signal allocated via the selector, and a control circuit that controls the switching circuit to allocate a signal from the light receiving elements to one of the amplifiers, and controls the selector to allocate the signal amplified by the amplifier circuit to one of the second processing circuits.

### TECHNICAL FIELD

The present disclosure relates to a reception control device and the like that control reception of an optical signal propagating in a space.

### BACKGROUND ART

In optical space communication, an optical signal (hereinafter, also referred to as a spatial optical signal) propagating in a space is transmitted and received without using a medium such as an optical fiber. In order to receive a spatial optical signal propagating in a wide space, it is preferable to use a lens having as large a diameter as possible. For optical space communication, a light receiving element having a small capacitance is adopted in order to perform high-speed communication. Such a light receiving element has a small light receiving portion. Since a focal length of the lens is limited, it is difficult to guide spatial optical signals arriving from various directions to the small light receiving portion by using the large-diameter lens.

PTL 1 discloses an optical signal device that receives an optical signal via a medium such as an optical fiber. The device of PTL 1 includes an array of pixels having light receiving elements for receiving input signal light. The device of PTL 1 selects outputs of the pixels in the array, and adds and outputs the selected pixel outputs. Furthermore, the device of PTL 1 includes an amplifier that amplifies a plurality of pixel outputs.

### CITATION LIST

### Patent Literature

PTL 1: WO 2008/114314 A1

### SUMMARY OF INVENTION

### Technical Problem

In the device of PTL 1, many pixels are connected to one amplifier. Therefore, in the device of PTL 1, when light receiving elements connected to the same amplifier are used for communication, the optical signal cannot be received by other light receiving elements connected to the amplifier. In addition, in the device of PTL 1, the number of circuits connected to one amplifier becomes enormous, and a reception speed for the optical signal decreases. That is, the device of PTL 1 cannot implement continuous optical space communication at a stable communication speed.

An object of the present disclosure is to provide a reception control device and the like that can implement continuous optical space communication at a stable communication speed.

### Solution to Problem

A reception control device according to an aspect of the present disclosure includes a first processing circuit that includes a switching circuit including a switch connected to each of a plurality of light receiving elements, a selection switch arranged for each group to which the plurality of light receiving elements are allocated, and a changeover switch that switches an output destination of the selection switch for each group, and an amplifier circuit including a plurality of amplifiers connected to an output of the switching circuit, a selector that is connected to an output of the first processing circuit, at least one second processing circuit that is arranged downstream of the selector and decodes a signal allocated via the selector, and a control circuit that controls the switching circuit to allocate a signal from each of the plurality of light receiving elements to any one of the plurality of amplifiers, and controls the selector to allocate the signal amplified by the amplifier circuit to any one of the second processing circuits.

A reception control method according to an aspect of the present disclosure includes: controlling, by a control circuit, a first processing circuit including a switching circuit that includes a first switch circuit including a switch connected to each of a plurality of light receiving elements and a second switch circuit switching an output destination of each group in which some of a plurality of the switches included in the first switch circuit are integrated, and an amplifier circuit including a plurality of amplifiers connected to an output of the switching circuit, to allocate a signal from each of the plurality of light receiving elements to any one of the plurality of amplifiers connected to the output of the switching circuit, and controlling, by the control circuit, a selector connected to outputs of the plurality of amplifiers to allocate the signal amplified by the amplifier circuit to any one of a plurality of second processing circuits that decode the signal output from the first processing circuit.

A program according to an aspect of the present disclosure causes a computer to execute processing of: controlling a first processing circuit including a switching circuit that includes a first switch circuit including a switch connected to each of a plurality of light receiving elements and a second switch circuit switching an output destination of each group in which some of a plurality of the switches included in the first switch circuit are integrated, and an amplifier circuit including a plurality of amplifiers connected to an output of the switching circuit, to allocate a signal from each of the plurality of light receiving elements to any one of the plurality of amplifiers connected to the output of the switching circuit, and controlling a selector connected to outputs of the plurality of amplifiers to allocate the signal amplified by the amplifier circuit to any one of a plurality of second processing circuits that decode the signal output from the first processing circuit.

### Advantageous Effects of Invention

According to the present disclosure, it is possible to provide the reception control device and the like that can implement continuous optical space communication at a stable communication speed.

### BRIEF DESCRIPTION OF DRAWINGS

FIG. 1 is a conceptual view illustrating an example of a configuration of a light reception device according to a first example embodiment.

FIG. 2 is a conceptual view for explaining an example of light collection by a ball lens of the light reception device according to the first example embodiment.

FIG. 3 is a conceptual view illustrating an example of a configuration of a light receiver included in the light reception device according to the first example embodiment.

FIG. 4 is a conceptual view illustrating an example of reception of an optical signal by a light receiving element included in a light receiving element array included in the light reception device according to the first example embodiment.

FIG. 5 is a conceptual view illustrating an example of reception of a spatial optical signal by the light reception device according to the first example embodiment.

FIG. 6 is a conceptual view illustrating another example of the reception of the spatial optical signal by the light reception device 5 according to the first example embodiment.

FIG. 7 is a block diagram illustrating an example of a configuration of a reception control device included in the light reception device according to the first example embodiment.

FIG. 8 is a conceptual view illustrating an example of a configuration of a first processing circuit included in the reception control device included in the light reception device according to the first example embodiment.

FIG. 9 is a conceptual view for explaining an example of light reception control for the spatial optical signal in the light reception device according to the first example embodiment.

FIG. 10 is a conceptual view for explaining an example of the light reception control for the spatial optical signal in the light reception device according to the first example embodiment.

FIG. 11 is a conceptual view for explaining an example of the light reception control for the spatial optical signal in the light reception device according to the first example embodiment.

FIG. 12 is a conceptual view for explaining an example of the light reception control for the spatial optical signal in the light reception device according to the first example embodiment.

FIG. 13 is a conceptual view for explaining an example of the light reception control for the spatial optical signal in the light reception device according to the first example embodiment.

FIG. 14 is a conceptual view for explaining an example of the light reception control for the spatial optical signal in the light reception device according to the first example embodiment.

FIG. 15 is a conceptual view illustrating an example of a configuration of a light receiver included in a light reception device according to Modified Example 1 of the first example embodiment.

FIG. 16 is a conceptual view illustrating an example of a configuration of a light receiver included in a light reception device according to Modified Example 2 of the first example embodiment.

FIG. 17 is a conceptual view for explaining an example of light reception control for a spatial optical signal according to the related art.

FIG. 18 is a block diagram illustrating an example of a configuration of a communication device according to a second example embodiment.

FIG. 19 is a conceptual view illustrating an example of a configuration of a transmission device included in the communication device according to the second example embodiment.

FIG. 20 is a conceptual view illustrating an example of a configuration of a communication device according to the second example embodiment.

FIG. 21 is a conceptual view for explaining Application Example 1 according to the second example embodiment.

FIG. 22 is a conceptual view for explaining an example of a configuration of a reception control device according to a third example embodiment.

FIG. 23 is a block diagram illustrating an example of a hardware configuration that executes control and processing according to each example embodiment.

### EXAMPLE EMBODIMENT

Hereinafter, example embodiments of the present invention will be described with reference to the drawings. However, the example embodiments described below have technically preferable limitations for carrying out the present invention, but the scope of the invention is not limited to the following. In all the drawings used in the following description of the example embodiments, the same reference signs are given to the same parts unless there is a particular reason. Further, in the following example embodiments, repeated description of similar configurations/operations may be omitted.

In all the drawings used for description of the following example embodiments, directions of arrows in the drawings are merely examples and do not limit directions of light and signals. In addition, a line indicating a trajectory of light in the drawings is conceptual and does not accurately indicate an actual traveling direction or state of light. For example, in the drawings, a change in traveling direction or state of light due to refraction, reflection, diffraction, diffusion, or the like at an interface between air and a substance may be omitted, or a light flux may be expressed by one line.

### First Example Embodiment

First, a light reception device according to a first example embodiment will be described with reference to the drawings. The light reception device of the present example embodiment is used for optical space communication in which an optical signal (hereinafter, also referred to as a spatial optical signal) propagating in a space is transmitted and received without using a medium such as an optical fiber. The light reception device of the present example embodiment may be used for applications other than the optical space communication as long as the reception device receives light propagating in a space. In the present example embodiment, unless otherwise specified, the spatial optical signal is regarded as parallel light because the spatial optical signal arrives from a sufficiently distant position.

### (Configuration)

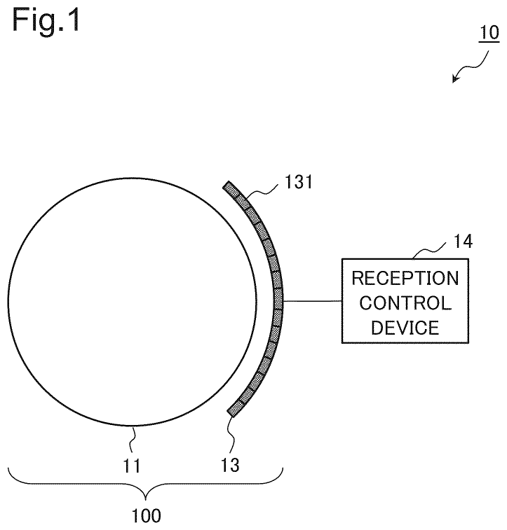

FIG. 1 is a conceptual view illustrating an example of a configuration of a light reception device 10 of the present example embodiment. The light reception device 10 includes a ball lens 11, a light receiving element array 13, and a reception control device 14. The ball lens 11 and the light receiving element array 13 are included in a light receiver 100. FIG. 1 is a plan view of the light receiver 100 as viewed from above. The light receiving element array 13 includes a plurality of light receiving elements 131 arranged in an arc shape. A positional relationship between the ball lens 11 and the light receiving element array 13 is fixed by a support (not illustrated). In the present example embodiment, the support for fixing the ball lens 11 and the light receiving element array 13 is omitted.

The ball lens 11 is a spherical lens. The ball lens 11 is an optical element that collects the spatial optical signal arriving from the outside. The ball lens 11 has a spherical shape when viewed from any angle. The ball lens 11 collects the incident spatial optical signal. Light (also referred to as an optical signal) derived from the spatial optical signal collected by the ball lens 11 is collected toward a light collecting region. The ball lens 11 has a spherical shape and thus collects the spatial optical signal arriving from any direction. That is, the ball lens 11 exhibits similar light collecting performance for the spatial optical signal arriving from any direction.

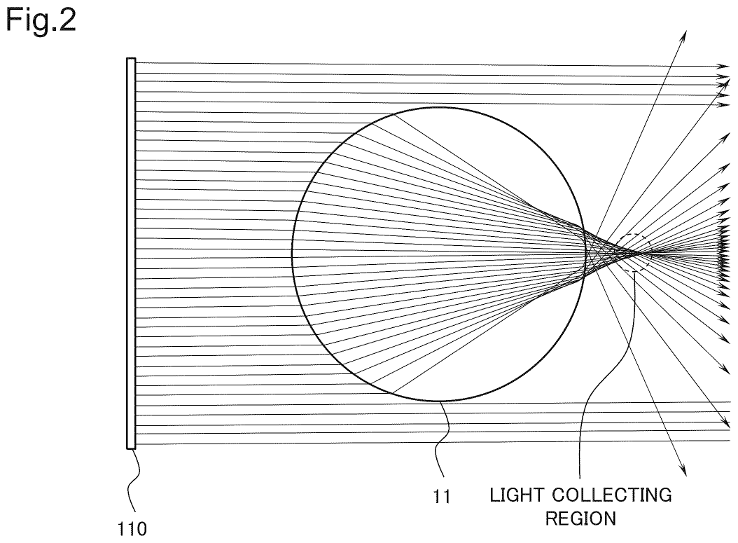

FIG. 2 is a conceptual view illustrating an example of a trajectory of light collected by the ball lens 11.

In the example of FIG. 2, light emitted from a light source 110 that emits parallel light is emitted toward the ball lens 11. The light emitted to the ball lens 11 is refracted when entering the inside of the ball lens 11. The light traveling inside the ball lens 11 is refracted again when being emitted to the outside of the ball lens 11. Most of the light refracted by the ball lens 11 is collected in the light collecting region. Light incident from the periphery of the ball lens 11 is emitted in a direction deviating from the light collecting region when being emitted from the ball lens 11.

For example, the ball lens 11 can be formed of a material such as glass, crystal, or resin. In a case of receiving a spatial optical signal in a visible range, a material that transmits/refracts light in the visible range can be applied to the ball lens 11. Examples of the material that transmits/refracts light in the visible range include glass, crystal, and resin. For example, optical glass such as crown glass or flint glass can be applied to the ball lens 11. For example, crown glass such as boron kron (BK) can be applied to the ball lens 11. For example, flint glass such as lanthanum schwerflint (LaSF) can be applied to the ball lens 11. For example, quartz glass can be applied to the ball lens 11. For example, crystal such as sapphire can be applied to the ball lens 11. For example, a transparent resin such as acryl can be applied to the ball lens 11. In a case where the spatial optical signal is light of a near-infrared range (hereinafter, also referred to as a near-infrared ray), a material that transmits a near-infrared ray is used for the ball lens 11. For example, in a case of receiving the spatial optical signal of the near-infrared range of about 1.5 micrometers (μm), a material such as silicon can be applied to the ball lens 11 in addition to glass, crystal, resin, and the like. In a case where the spatial optical signal is light of an infrared range (hereinafter, also referred to as an infrared ray), a material that transmits an infrared ray is used for the ball lens 11. For example, in a case where the spatial optical signal is an infrared ray, a silicon-based material, a germanium-based material, or a chalcogenide-based material can be applied to the ball lens 11. The material of the ball lens 11 is not limited as long as light of a wavelength region of the spatial optical signal can be transmitted/refracted. The material of the ball lens 11 may be appropriately selected according to a required refractive index or use.

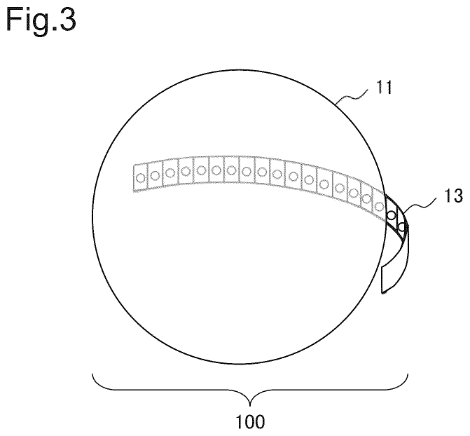

FIG. 3 is a perspective view of the light receiver 100 including the ball lens 11 and the light receiving element array 13. FIG. 3 is a perspective view of the light receiver 100 viewed from a diagonally elevated perspective on an incident surface side. The light receiving element array 13 has an arc shape with respect to the center of the ball lens 11. The light receiving element array 13 has an arc-shaped long side and a linear short side. The long side and the short side are orthogonal to each other. The plurality of light receiving elements 131 included in the light receiving element array 13 are arranged in such a way that light receiving portions thereof face the center of the ball lens 11.

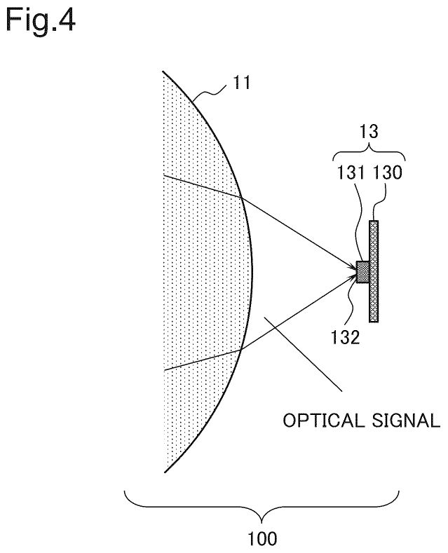

FIG. 4 is a cross-sectional view of a part of the light receiver 100. The light receiver 100 includes the ball lens 11 and the light receiving element array 13. FIG. 4 illustrates a cross section in an example in which the light receiving element 131 is arranged on an arc-shaped substrate 130. FIG. 4 illustrates a trajectory of light collected by the ball lens 11. The optical signal is collected by the ball lens 11 in the light collecting region where the light receiving element array 13 is arranged. The collected optical signal is received by any one of the light receiving elements 131 included in the light receiving element array 13. An optical signal deviating from the light receiving portion 132 of the light receiving element 131 is not received by the light receiving element 131.

The light receiving element array 13 includes the plurality of light receiving elements 131 arranged in an arc shape in a circumferential direction of the ball lens 11. The number of light receiving elements 131 included in the light receiving element array 13 is not limited. The light receiving element array 13 is arranged downstream of the ball lens 11. The plurality of light receiving elements 131 each include the light receiving portion 132 that receives the optical signal derived from the spatial optical signal to be received. Each of the plurality of light receiving elements 131 is arranged in such a way that the light receiving portion 132 faces an emission surface of the ball lens 11. The light receiving portion 132 of each of the plurality of light receiving elements 131 is arranged at a position of the light collecting region of the ball lens 11. The optical signal collected by the ball lens 11 is received by the light receiving portion 132 of the light receiving element 131. A light receiving surface of each of the plurality of light receiving elements 131 includes a region (also referred to as a non-sensitive region) where the light receiving portion 132 is not positioned.

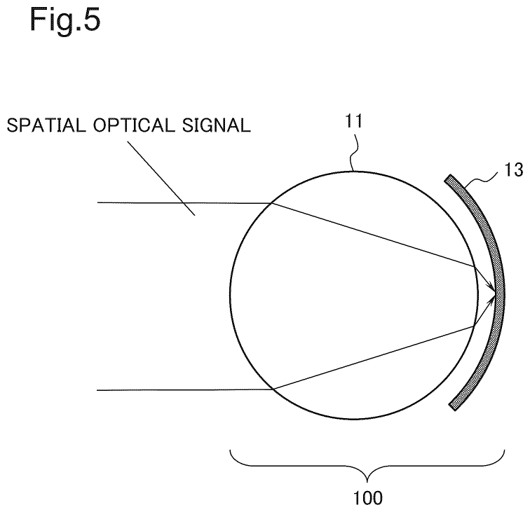

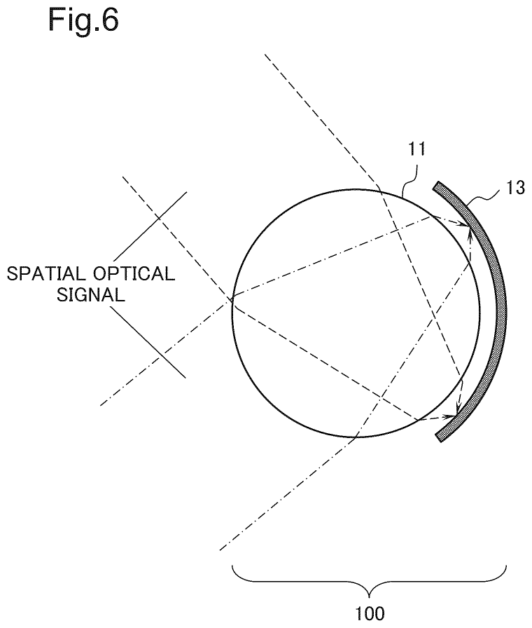

FIG. 5 is a conceptual view illustrating an example in which the light reception device 10 receives the spatial optical signal arriving from one direction. FIG. 6 is a conceptual view illustrating an example in which the light reception device 10 receives the spatial optical signals arriving from two directions. Since the ball lens 11 is a sphere, the light reception device 10 can uniformly receive the spatial optical signal arriving from any direction as long as the spatial optical signal is within a range where light can be received by the light receiving element array 13. For example, in a case where the arc-shaped long side of the light receiving element array 13 is set to be parallel to a horizontal plane, the light reception device 10 easily receives the spatial optical signal arriving in a horizontal direction from the same height. For example, in a case where the arc-shaped long side of the light receiving element array 13 is set to be perpendicular to the horizontal plane, the light reception device 10 similarly easily receives the spatial optical signal arriving from any height. An orientation of the arc-shaped long side of the light receiving element array 13 may be adjusted in accordance with an arrival direction of the spatial optical signal to be received.

Every several light receiving elements 131 among the plurality of light receiving elements 131 are grouped. For example, every four of the plurality of light receiving elements 131 adjacent to each other are grouped. The optical signal received by each of the plurality of light receiving elements 131 is allocated to each group and distributed to any one of a plurality of amplifiers (to be described later) included in the reception control device 14. The optical signal received by each of the plurality of light receiving elements 131 is amplified by the amplifier and then individually processed.

The light receiving element 131 receives light in a wavelength region of the spatial optical signal to be received. For example, the light receiving element 131 is sensitive to light of the visible range. For example, the light receiving element 131 is sensitive to light of an infrared range. The light receiving element 131 is sensitive to light having a wavelength in a band of 1.5 μm (micrometer), for example. Any wavelength band of the light received by the light receiving element 131 can be set in accordance with a wavelength of the spatial optical signal transmitted from a transmission device (not illustrated). The wavelength band of the light received by the light receiving element 131 may be set to, for example, a band of 0.8 μm, a band of 1.55 μm, or a band of 2.2 μm. Further, the wavelength band of the light received by the light receiving element 131 may be, for example, a band of 0.8 to 1.0 μm. A shorter wavelength band is advantageous for optical space communication during rainfall because absorption by moisture in the atmosphere is small. In a case where the light receiving element 131 is saturated with intense sunlight, the light receiving element cannot read the optical signal derived from the spatial optical signal. Therefore, a color filter that selectively passes light of the wavelength band of the spatial optical signal may be installed upstream of the light receiving element 131.

For example, the light receiving element 131 can be implemented by an element such as a photodiode or a phototransistor. For example, the light receiving element 131 is implemented by an avalanche photodiode. The light receiving element 131 implemented by the avalanche photodiode can support high-speed communication. The light receiving element 131 may be implemented by an element other than a photodiode, a phototransistor, or an avalanche photodiode as long as an optical signal can be converted into an electric signal. In order to increase the communication speed, the light receiving portion 132 of the light receiving element 131 is preferably as small as possible. For example, the light receiving portion 132 of the light receiving element 131 has a square light receiving surface of which a side has a size of about 5 mm (mm). For example, the light receiving portion 132 of the light receiving element 131 has a circular light receiving surface having a diameter of about 0.1 to 0.3 mm. It is sufficient if the size and shape of the light receiving portion 132 of the light receiving element 131 are selected according to the wavelength band of the spatial optical signal, the communication speed, and the like.

The light receiving element 131 converts the received optical signal into an electric signal. The light receiving element 131 outputs the converted electric signal to the reception control device 14. Although only one line (path) is illustrated between the light receiving element array 13 and the reception control device 14 in FIG. 1, this does not indicate that the light receiving element array 13 and the reception control device 14 are connected by one path. For example, the light receiving element array 13 and the reception control device 14 are connected by a plurality of paths. For example, each of the light receiving elements 131 included in the light receiving element array 13 may be individually connected to the reception control device 14. For example, some of the light receiving elements 131 included in the light receiving element array 13 may be grouped, and the group may be connected to the reception control device 14.

The reception control device 14 acquires a signal output from each of the plurality of light receiving elements 131. The reception control device 14 includes the plurality of amplifiers. The reception control device 14 includes a switching circuit that distributes a signal from each of the plurality of light receiving elements 131 to any one of the plurality of amplifiers. The reception control device 14 distributes the signal output from each of the plurality of light receiving elements 131 to any one of the plurality of amplifiers. In a case of distributing a new optical signal, the reception control device 14 distributes the signal to an available amplifier among the plurality of amplifiers. The reception control device 14 amplifies the signal from each of the plurality of light receiving elements 131 by any amplifier. The reception control device 14 decodes the amplified signal. The reception control device 14 analyzes the decoded signal from a communication target. For example, the reception control device 14 collectively analyzes the signals of the plurality of grouped light receiving elements 131. In a case where the signals of the plurality of light receiving elements 131 are collectively analyzed, it is possible to implement the single-channel light reception device 10 that communicates with a single communication target. For example, the reception control device 14 individually analyzes the signal for each of the plurality of light receiving elements 131. In a case where the signal is individually analyzed for each of the plurality of light receiving elements 131, it is possible to implement the multi-channel light reception device 10 that simultaneously communicates with a plurality of communication targets. The signal decoded by the reception control device 14 is used for any purpose. The use of the signal decoded by the reception control device 14 is not particularly limited.

### [Reception Control Device]

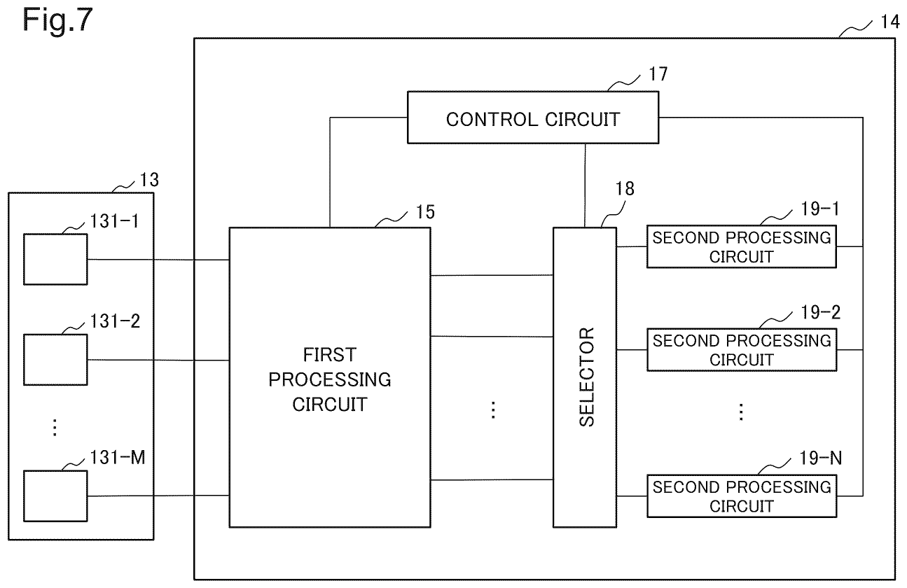

Next, an example of a detailed configuration of the reception control device 14 included in the light reception device 10 will be described with reference to the drawings. FIG. 7 is a block diagram illustrating an example of the configuration of the reception control device 14. The reception control device 14 includes a first processing circuit 15, a control circuit 17, a selector 18, and a plurality of second processing circuits 19-1 to 19-N (N is a natural number). In the example of FIG. 7, the number of light receiving elements 131 included in the light receiving element array 13 is M (M is a natural number). FIG. 7 illustrates an example of the configuration of the reception control device 14, and does not limit the configuration of the reception control device 14.

The first processing circuit 15 is connected to a plurality of light receiving elements 131-1 to 131-M. The first processing circuit 15 amplifies a signal for each group of several light receiving elements 131 included in the plurality of light receiving elements 131-1 to 131-M.

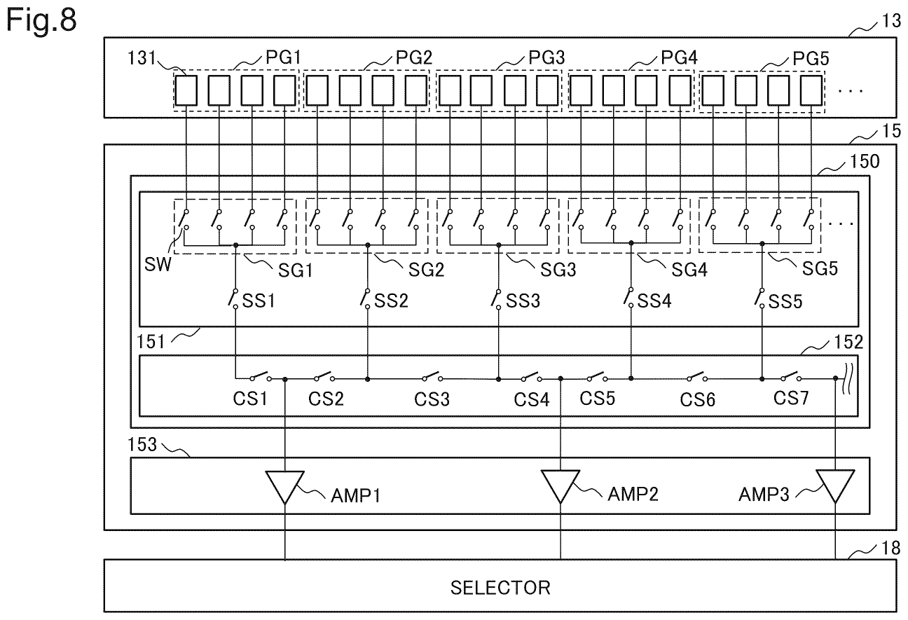

FIG. 8 is a conceptual view illustrating an example of a configuration of the first processing circuit 15. The first processing circuit 15 includes a switching circuit 150 and an amplifier circuit 153. FIG. 8 illustrates an example in which the plurality of light receiving elements 131-1 to 131-M included in the light receiving element array 13 are distributed to any one of a plurality of light receiving element groups PG (photodiode group). FIG. 8 illustrates an example in which PGs each including four light receiving elements 131 are distributed as five light receiving element groups PG (PG1, PG2, PG3, PG4, and PG5).

The switching circuit 150 includes a first switch circuit 151 and a second switch circuit 152. The first switch circuit 151 includes a plurality of switches SW and a plurality of selection switches SS. Each of the plurality of switches SW is associated with any one of the plurality of light receiving elements 131-1 to 131-M. The plurality of switches SW are distributed to any switch group SG associated with any one of the plurality of light receiving element groups PG. In FIG. 8, only the switch SW at the left end is denoted by reference sign “SW” due to limitations of space on the page, but all the switches SW included in the switch group SG have the same configuration. FIG. 8 illustrates an example in which the first switch circuit 151 includes a selection switch SS1, a selection switch SS2, a selection switch SS3, a selection switch SS4, and a selection switch SS5.

In the example of FIG. 8, each of the plurality of selection switches SS is associated with any one of the switch groups SG each including four light receiving elements 131. In the example of FIG. 8, each of the plurality of selection switches SS is arranged in association with each of the light receiving element groups PG in which some of the plurality of light receiving elements 131-1 to 131-M are grouped. An input end of each of the plurality of selection switches SS is connected to an output end of any switch group SG. Therefore, each of the plurality of selection switches SS is associated with any one of the light receiving element groups PG. The plurality of selection switches SS are used for selection control of the light receiving element group PG.

In the example of FIG. 8, each of the five switch groups SG (SG1, SG2, SG3, SG4, and SG5) is arranged in association with each of the five light receiving element groups PG (PG1, PG2, PG3, PG4, and PG5). The switch group SG1 is associated with the light receiving element group PG1. An input end of each of the plurality of switches SW included in the switch group SG1 is connected to any one of the light receiving elements 131 included in the light receiving element group PG1. The output end of each of the plurality of switches SW included in the switch group SG1 is connected to the input end of the selection switch SS1. The switch group SG2 is associated with the light receiving element group PG2. An input end of each of the plurality of switches SW included in the switch group SG2 is connected to any one of the light receiving elements 131 included in the light receiving element group PG2. The output end of each of the plurality of switches SW included in the switch group SG2 is connected to the input end of the selection switch SS2. The switch group SG3 is associated with the light receiving element group PG3. An input end of each of the plurality of switches SW included in the switch group SG3 is connected to any one of the light receiving elements 131 included in the light receiving element group PG3. The output end of each of the plurality of switches SW included in the switch group SG3 is connected to the input end of the selection switch SS3. The switch group SG4 is associated with the light receiving element group PG4. An input end of each of the plurality of switches SW included in the switch group SG4 is connected to any one of the light receiving elements 131 included in the light receiving element group PG4. The output end of each of the plurality of switches SW included in the switch group SG4 is connected to the input end of the selection switch SS4. The switch group SG5 is associated with the light receiving element group PG5. An input end of each of the plurality of switches SW included in the switch group SG5 is connected to any one of the light receiving elements 131 included in the light receiving element group PG5. The output end of each of the plurality of switches SW included in the switch group SG5 is connected to the input end of the selection switch SS5.

The output end of each of the plurality of switch groups SG included in the first switch circuit 151 is connected to the input end of any one of the plurality of selection switches SS. The plurality of switches SW included in each of the plurality of switch groups SG are opened and closed under the control of the control circuit 17. The selection switch SS connected to each of the plurality of switch groups SG is also opened and closed under the control of the control circuit 17. A signal included in an optical signal received by the light receiving element 131 connected to a path on which the switch SW and the selection switch SS are closed is output to the second switch circuit.

The second switch circuit 152 includes a plurality of changeover switches CS. The plurality of changeover switches CS included in the second switch circuit 152 are opened and closed under the control of the control circuit 17. An output from each of the plurality of selection switches SS included in the first switch circuit 151 is distributed to any one of a plurality of amplifiers AMP included in the amplifier circuit 153 according to opened/closed states of the plurality of changeover switches CS. As a result, connection between any one of the light receiving element groups PG and the amplifier AMP is established. FIG. 8 illustrates an example in which the second switch circuit 152 includes the plurality of changeover switches CS (CS1, CS2, CS3, CS4, CS5, CS6, CS7, and the like). The changeover switch CS has a first end and a second end. The first ends of the plurality of changeover switches CS are connected to the output end of at least one of the plurality of selection switches SS included in the first switch circuit 151. The second ends of the plurality of changeover switches CS are connected to any one of the plurality of amplifiers AMP included in the amplifier circuit 153. FIG. 8 illustrates an example in which four light receiving element groups PG are allocated to one amplifier AMP. For example, four light receiving element groups PG may be allocated to one amplifier AMP. For example, the number of light receiving element groups allocated to one amplifier AMP can be arbitrarily set.

In the example of FIG. 8, the output end of the selection switch SS1 is connected to the first end of the changeover switch CS1. The output end of the selection switch SS2 is connected to the first ends of the changeover switch CS2 and the changeover switch CS3. The output end of the selection switch SS3 is connected to the first ends of the changeover switch CS3 and the changeover switch CS4. The output end of the selection switch SS4 is connected to the first ends of the changeover switch CS5 and the changeover switch CS6. The output end of the selection switch SS5 is connected to the first ends of the changeover switch CS6 and the changeover switch CS7.

The second end of each of the plurality of changeover switches CS included in the second switch circuit 152 is connected to the input end of each of the plurality of amplifiers AMP included in the amplifier circuit 153. The light receiving elements 131 included in the light receiving element array 13 can be connected to the amplifiers AMP included in the amplifier circuit 153 according to a combination of the opened/closed states of the plurality of switches SW, the plurality of selection switches SS, and the plurality of changeover switches CS. The changeover switch CS is used to distribute a signal of each light receiving element group PG included in the light receiving element array 13 to any amplifier AMP included in the amplifier circuit 153.

The amplifier circuit 153 includes the plurality of amplifiers AMP. In the example of FIG. 8, the amplifier circuit 153 includes the plurality of amplifiers AMP (AMP1, AMP2, AMP3, and the like). The input end of each of the plurality of amplifiers AMP is connected to the second end of any one of the plurality of changeover switches CS included in the second switch circuit 152. Each amplifier AMP acquires a signal input via the second switch circuit 152. Each amplifier AMP amplifies the acquired signal. An amplification factor for the signal in the amplifier AMP is not particularly limited.

An output end of each of the plurality of amplifiers AMP is connected to the selector 18. The signal amplified by each amplifier is output to the selector 18. Signals from all of the plurality of light receiving elements 131 included in the light receiving element array 13 can be input to the amplifiers AMP according to a combination of the opened/closed states of the plurality of switches included in the switching circuit 150. A signal from any one of the plurality of light receiving elements 131 is input to each amplifier AMP according to a combination of the switches closed by the control circuit 17.

In the example of FIG. 8, the input end of the amplifier AMP1 is connected to the second ends of the changeover switch CS1 and the changeover switch CS2. The input end of the amplifier AMP2 is connected to the second ends of the changeover switch CS4 and the changeover switch CS5. The input end of the amplifier AMP3 is connected to the second end of the changeover switch CS7. The output ends of the amplifier AMP1, the amplifier AMP2, and the amplifier AMP3 are connected to the selector 18.

For example, the first processing circuit 15 may include a high-pass filter (not illustrated). For example, the high-pass filter is arranged between the light receiving element array 13 and the first processing circuit 15. The high-pass filter acquires a signal from the light receiving element 131. The high-pass filter selectively passes a signal of a high-frequency component associated to a wavelength band of the spatial optical signal in the acquired signal. The high-pass filter cuts a signal derived from ambient light such as sunlight. For example, a band pass filter that selectively passes a signal in a wavelength band of the spatial optical signal may be configured instead of the high-pass filter. When the light receiving element 131 is saturated with intense sunlight, the optical signal cannot be read. Therefore, a color filter that selectively passes light of the wavelength band of the spatial optical signal may be installed upstream of the light receiving element array 13.

For example, the first processing circuit 15 includes an output monitor (not illustrated). The output monitor monitors an output value of each of the plurality of amplifiers AMP included in the amplifier circuit 153. The output monitor outputs a signal exceeding a predetermined output value among the signals amplified by the amplifiers AMP to the selector 18. Among the signals output to the selector 18, a signal to be received is allocated to any one of the plurality of second processing circuits 19-1 to 19-N under the control of the control circuit 17. The signal to be received is a spatial optical signal from a communication device (not illustrated) that is a communication target. A signal from the light receiving element 131 that is not used for receiving the spatial optical signal is not output to the second processing circuit 19.

For example, the first processing circuit 15 may include an integrator (not illustrated) as the output monitor (not illustrated). The integrator acquires a signal output from the high-pass filter. The integrator integrates the acquired signal. The integrator outputs the integrated signal to the control circuit 17. The integrator is arranged to measure an intensity of the spatial optical signal received by the light receiving element 131. Since the spatial optical signal received in a state where a beam diameter is not narrowed has a lower intensity than that in a case where the beam diameter is narrowed, it is difficult to measure a voltage of the signal amplified only by the amplifier. In a case of using the integrator, for example, the voltage of the signal can be increased to a level at which the voltage can be measured by integrating a signal in a period of several milliseconds to several tens of milliseconds.

The control circuit 17 controls the opened/closed states of the plurality of switches SW and the plurality of selection switches SS included in the switching circuit 150 of the first processing circuit 15. As a result, the light receiving element 131 used to receive the optical signal and the amplifier AMP used to amplify the signal from the light receiving element 131 are connected. The control circuit 17 allocates the signal from the light receiving element 131 to the amplifier AMP that is not used for scanning or communication among the plurality of amplifiers AMP included in the amplifier circuit 153. Details of an example of control of the switching circuit 150 by the control circuit 17 will be described later. The control circuit 17 controls the selector 18 in such a way as to allocate the signal from the light receiving element 131 to any one of the plurality of second processing circuits 19-1 to 19-N. For example, the control circuit 17 allocates new scanning or communication to the second processing circuit 19 that is not in use.

For example, the control circuit 17 acquires a signal output from the first processing circuit 15. In other words, the control circuit 17 acquires a signal derived from the optical signal received by each of the plurality of light receiving elements 131-1 to 131-M. The control circuit 17 may acquire the optical signal from the first processing circuit 15 or may acquire the optical signal from the second processing circuit 19. The control circuit 17 may acquire only an output value of the optical signal. For example, the control circuit 17 compares read values of the signals from the plurality of light receiving elements 131 adjacent to each other. The control circuit 17 selects the light receiving element 131 having the highest signal intensity according to the comparison result. The control circuit 17 allocates any one of the amplifiers AMP to the selected light receiving element 131. The control circuit 17 performs control to close at least one of the plurality of switches arranged between the selected light receiving element 131 and the selected amplifier AMP, thereby establishing connection between the light receiving element 131 and the amplifier AMP. By connecting the light receiving element 131 and the amplifier AMP, connection between the light receiving element 131 and the selector is also established.

For example, in a case where the position of the communication target is specified in advance, the control circuit 17 does not estimate the arrival direction of the spatial optical signal, and outputs the signals output from the light receiving elements 131-1 to 131-M to any one preset second processing circuit 19. For example, in a case where the position of the communication target is not specified in advance, the control circuit 17 selects the second processing circuit 19 as an output destination of the signals output from the light receiving elements 131-1 to 131-M. For example, during scanning of the communication target, the control circuit 17 sequentially measures received light intensities of the optical signals received by the plurality of light receiving elements 131 included in the light receiving element array 13. For example, the control circuit 17 selects the light receiving element 131 having the maximum received light intensity of the optical signal as the light receiving element 131 to be allocated to receive the optical signal. As the control circuit 17 selects the light receiving element 131, the arrival direction of the spatial optical signal can be estimated. Selection of the light receiving element 131 by the control circuit 17 corresponds to specification of a communication device as a transmission source of the spatial optical signal. Further, allocation of the signal from the light receiving element 131 selected by the control circuit 17 to any one of the plurality of second processing circuits corresponds to association of the specified communication target with the light receiving element 131 that receives the spatial optical signal from the communication target. The control circuit 17 can specify the communication device as the transmission source of the optical signal (spatial optical signal) based on the optical signal received by the plurality of light receiving elements 131-1 to 131-M. For example, the control circuit allocates the second processing circuit 19 used for communication with the communication target according to the intensity of the received optical signal, and establishes communication with the communication target.

For example, it is assumed that, when every eight light receiving elements 131 among 64 light receiving elements 131 are allocated to each of eight amplifiers AMP, one amplifier AMP covers an angle of 15 degrees. Within the angle of 15 degrees, the width is 13.2 meters at a point 50 meters ahead, and is 26.3 meters at a point 100 meters ahead. With such a width, there is a possibility that signals derived from the spatial optical signals transmitted from different communication targets are input to one amplifier AMP. When the signals derived from the spatial optical signals transmitted from different communication targets are input to one amplifier AMP, interference between the spatial optical signals from the communication targets occurs. In order to avoid interference from the same direction, it is necessary to leave an interval equivalent to two or three light receiving elements 131. That is, interference can be avoided by arranging one amplifier AMP for every three or four light receiving elements 131. In a general method, 16 to 21 amplifiers AMP are required in a case where one amplifier AMP is arranged for every three or four light receiving elements. In addition, in order to accurately detect a direction of the communication target, it is necessary to configure the light receiving element group PG including at least four light receiving elements 131. In the general method, in a case of configuring the light receiving element group PG including four light receiving elements 131, 64 light receiving elements are grouped into 16 groups, and thus, 16 amplifier circuits are required.

In the present example embodiment, the plurality of switches SW are associated with the light receiving element groups PG, and the signals are allocated to the plurality of amplifiers AMP according to a combination of the opened/closed states of the plurality of selection switches SS and the plurality of changeover switches CS. Therefore, according to the present example embodiment, the number of amplifiers can be reduced while forming a group with an appropriate number of light receiving elements, and thus, the direction of the communication target can be accurately detected. For example, the number of light receiving elements 131 included in the light receiving element group PG is preferably set to be equal to or less than an angle at which the communication device can be positioned when viewed from the perspective of the light reception device 10. With this setting, it is possible to avoid interference between the spatial optical signals transmitted from a plurality of communication targets. That is, the plurality of light receiving elements 131 included in the light receiving element array 13 are allocated to any one of the light receiving element groups PG (groups) including a number of light receiving elements 131 that fall within a light receiving range in which the spatial optical signal transmitted from one communication target is received. In the present example embodiment, every four of the plurality of light receiving elements 131 included in the light receiving element array 13 are grouped.

The selector 18 is connected to the first processing circuit 15. The selector 18 is connected to the plurality of amplifiers AMP included in the amplifier circuit 153 of the first processing circuit 15. The signal amplified by the amplifier circuit 153 included in the first processing circuit 15 is input to the selector 18. The selector 18 outputs a signal to be received among the input signals to any one of the plurality of second processing circuits 19-1 to 19-N under the control of the control circuit 17. A signal not intended for reception is not output from the selector 18.

The signal from any one of the plurality of light receiving elements 131-1 to N allocated by the control circuit 17 is input to the plurality of second processing circuits 19-1 to 19-N. Each of the plurality of second processing circuits 19-1 to 19-N decodes the input signal. Each of the plurality of second processing circuits 19-1 to 19-N may be configured to execute some signal processing on the decoded signal, or may be configured to output the signal to an external signal processing device or the like (not illustrated).

The selector 18 selects a signal derived from the light receiving element 131 selected by the control circuit 17, whereby one second processing circuit 19 is allocated to one communication target. That is, the control circuit 17 allocates the signal derived from the spatial optical signal received from each of the plurality of communication targets by each of the plurality of light receiving elements 131-1 to 131-M to any one of the plurality of second processing circuits 19-1 to 19-N. As a result, optical space communication with the communication target is established. As a result, the light reception device 10 can read the signal derived from the spatial optical signal from the communication target on a channel set in any one of the second processing circuits 19. According to the method of the present example embodiment, spatial optical signals from a plurality of communication targets can be simultaneously read on a plurality of channels. For example, in order to simultaneously communicate with a plurality of communication targets, the spatial optical signals from the plurality of communication targets may be read in a time division manner on a single channel. When signals included in spatial optical signals from a plurality of communication targets are allocated to a plurality of channels, a transmission speed is faster as compared with a case where a single channel is used.

For example, the arrival direction of the spatial optical signal may be specified by primary scanning with low accuracy, and secondary scanning with high accuracy may be performed on the specified direction to specify the accurate position of the communication target. When communication with the communication target becomes possible, the accurate position of the communication target can be determined by exchanging a signal with the communication target. In a case where the position of the communication target is specified in advance, the processing of specifying the position of the communication target can be omitted.

### [Reception Control]

Next, reception control for the spatial optical signal in the reception control device 14 will be described with some examples. Hereinafter, a possible example of reception control in scanning of a communication target and reception control in communication with a communication target for which communication is established will be described. The following reception control is an example, and does not limit the reception control of the present example embodiment. In addition, the following reception control does not cover all the reception control of the present example embodiment. The reception control of the present example embodiment may include methods other than the following examples.

### Control Example 1

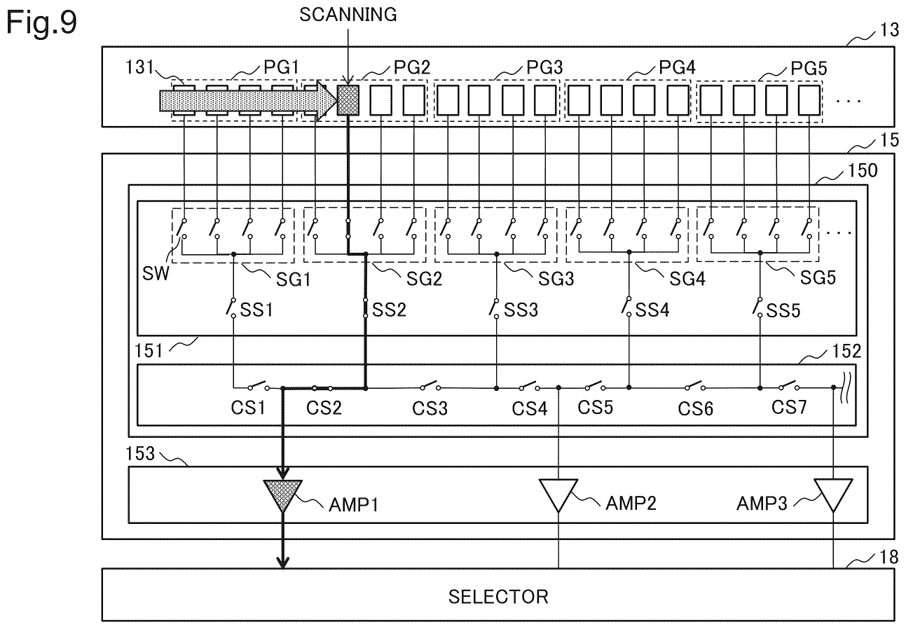

FIG. 9 is a conceptual view for explaining an example (Control Example 1) of the reception control for the spatial optical signal in the reception control device 14. The example of FIG. 9 relates to a mode for scanning a communication target (also referred to as a scanning mode).

In the example of FIG. 9, the light receiving element group PG2 and the amplifier AMP1 are connected. The control circuit 17 closes the second switch SW from the left in the switch group SG2, the selection switch SS2, and the changeover switch CS2. As a result, the light receiving element group PG2 and the amplifier AMP1 are connected. In FIG. 9, the light receiving element 131 being scanned and the amplifier AMP1 used for the scanning are indicated by hatching. A path between the light receiving element 131 being scanned and the amplifier AMP1 used for the scanning is indicated by a thick line as a path through which a signal being scanned propagates.

In the scanning mode, the control circuit 17 sequentially activates the light receiving elements 131 included in the light receiving element array 13, and selects the light receiving element 131 to be allocated to communication with the communication target. For example, the control circuit 17 selects the light receiving element 131 having the highest received optical signal intensity. For example, the control circuit 17 may allocate the light receiving element group PG including the light receiving element 131 having the highest received optical signal intensity to communication with the communication target. According to the present control example, the scanning mode for scanning the communication target can be set.

### Control Example 2

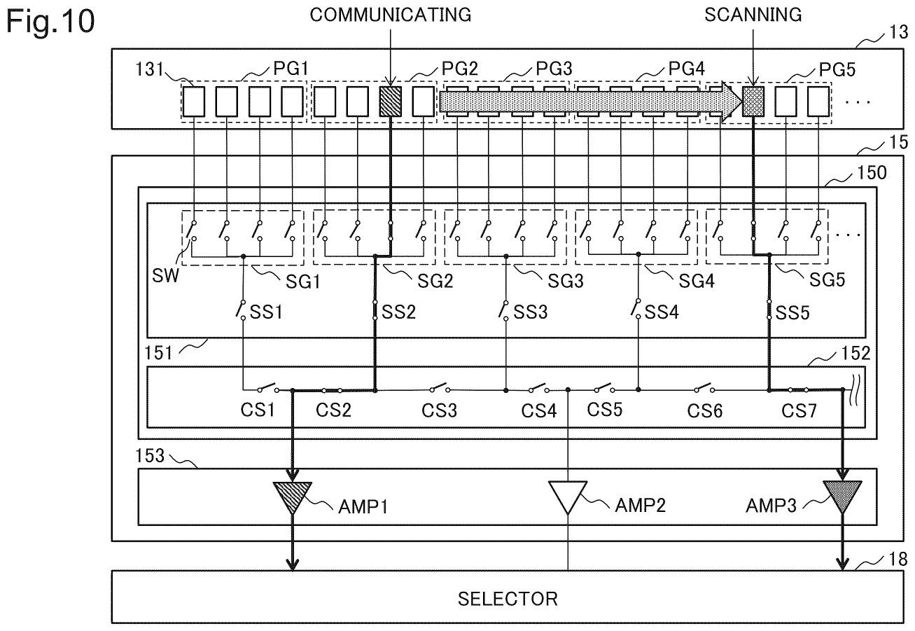

FIG. 10 is a conceptual view for explaining an example (Control Example 2) of the reception control for the spatial optical signal in the reception control device 14. The present control example is an example in which after communication with a communication target (first communication target) is established in Control Example 1, scanning of another communication target is continued. In the example of FIG. 10, a communication mode for communicating with a communication target and the scanning mode for scanning the communication target are executed in parallel.

In the example of FIG. 10, the light receiving element group PG2 and the amplifier AMP1 are connected. The control circuit 17 closes the third switch SW from the left in the switch group SG2, the selection switch SS2, and the changeover switch CS2. As a result, the light receiving element group PG2 and the amplifier AMP1 are connected. In FIG. 10, the light receiving element 131 in communication and the amplifier AMP1 used for the communication are indicated by hatching. A path between the light receiving element 131 in communication and the amplifier AMP1 used for the communication is indicated by a thick line as a path through which a signal in communication with the first communication target propagates.

In the example of FIG. 10, the light receiving element group PG5 and the amplifier AMP3 are connected. The control circuit 17 closes the second switch SW from the left in the switch group SG5, the selection switch SS5, and the changeover switch CS7. As a result, the light receiving element group PG5 and the amplifier AMP3 are connected. In FIG. 10, the light receiving element 131 being scanned and the amplifier AMP3 used for the scanning are indicated by hatching. A path between the light receiving element 131 being scanned and the amplifier AMP3 used for the scanning is indicated by a thick line as a path through which a signal being scanned propagates.

In the example of FIG. 10, the communication mode and the scanning mode are set in parallel. In the communication mode, the control circuit 17 fixes connection between the light receiving element 131 and the amplifier AMP between which communication is established. As for the light receiving element group PG not used for communication, the control circuit 17 sequentially activates the light receiving elements 131 included in the light receiving element array 13 and selects the light receiving element 131 to be allocated to communication with the communication target. For example, the control circuit 17 selects the light receiving element 131 having the highest received optical signal intensity. For example, the control circuit 17 may allocate the light receiving element group PG including the light receiving element 131 having the highest received optical signal intensity to communication with the communication target.

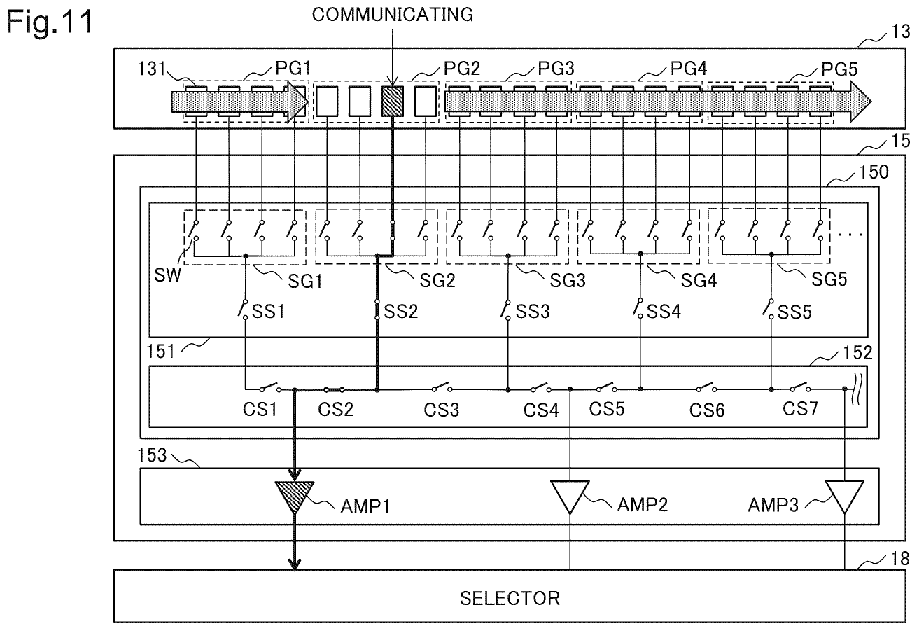

FIG. 11 illustrates a state in which the scanning of FIG. 10 is continued. The example of FIG. 11 illustrates a state in which scanning of the light receiving element group PG1 is completed after scanning of the light receiving element group PG3, the light receiving element group PG4, and the light receiving element group PG5. According to the present control example, the scanning mode can be set for the light receiving element groups PG other than the light receiving element group PG in communication.

### Control Example 3

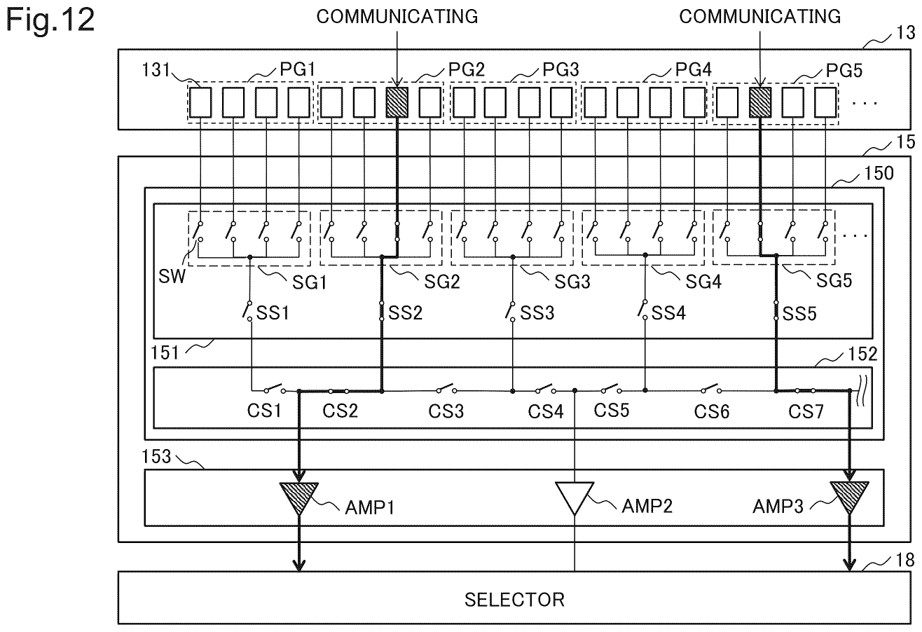

FIG. 12 is a conceptual view for explaining an example (Control Example 3) of the reception control for the spatial optical signal in the reception control device 14. The present control example shows a state after communication with the second communication target (second communication target) is established by Control Example 2. In the example of FIG. 12, communications with two communication targets (the first communication target and the second communication target) are performed in parallel.

In the example of FIG. 12, the light receiving element group PG2 and the amplifier AMP1 are connected. The control circuit 17 closes the third switch SW from the left in the switch group SG2, the selection switch SS2, and the changeover switch CS2. As a result, the light receiving element group PG2 and the amplifier AMP1 are connected. In FIG. 12, the light receiving element 131 in communication included in the light receiving element group PG2 and the amplifier AMP1 used for the communication are indicated by hatching. A path between the light receiving element 131 in communication included in the light receiving element group PG2 and the amplifier AMP1 used for the communication is indicated by a thick line as a path through which a signal in communication with the first communication target propagates.

In the example of FIG. 12, the light receiving element group PG5 and the amplifier AMP3 are connected. The control circuit 17 closes the second switch SW from the left in the switch group SG5, the selection switch SS5, and the changeover switch CS7. As a result, the light receiving element group PG5 and the amplifier AMP3 are connected. In FIG. 12, the light receiving element 131 in communication included in the light receiving element group PG5 and the amplifier AMP3 used for the communication are indicated by hatching. A path between the light receiving element 131 in communication included in the light receiving element group PG5 and the amplifier AMP3 used for the communication is indicated by a thick line as a path through which a signal in communication with the second communication target propagates.

In the example of FIG. 12, two communication modes are set in parallel. In the communication mode, the control circuit 17 fixes connection between the light receiving element 131 and the amplifier AMP between which communication is established. According to the present control example, communication with two communication targets can be established.

### Control Example 4

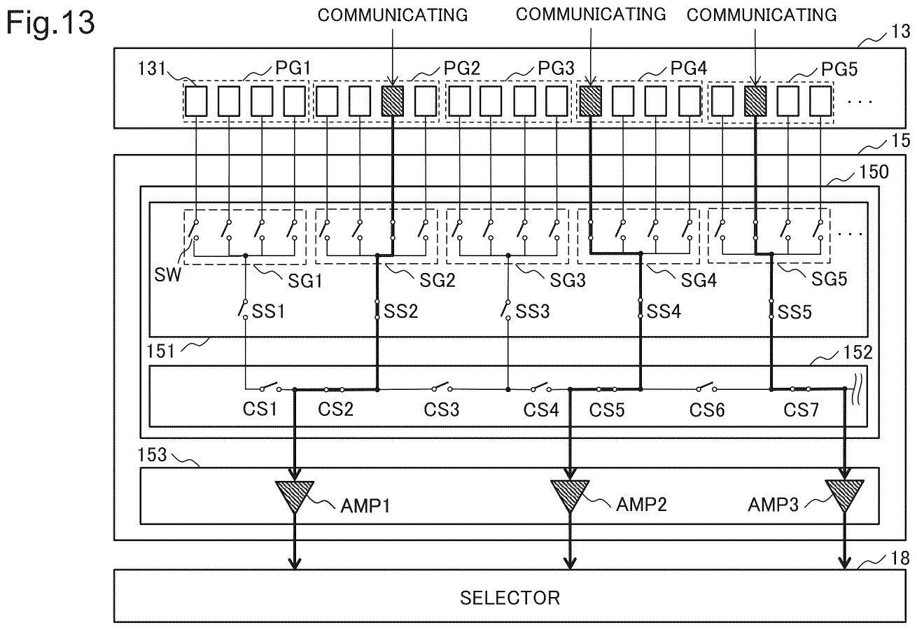

FIG. 13 is a conceptual view for explaining an example (Control Example 4) of the reception control for the spatial optical signal in the reception control device 14. The present control example is an example in which communication with a new communication target (third communication target) is established by new scanning after Control Example 3. In the example of FIG. 13, communications with three communication targets (the first communication target, the second communication target, and the third communication target) are performed in parallel.

In the example of FIG. 13, the light receiving element group PG2 and the amplifier AMP1 are connected. The control circuit 17 closes the third switch SW from the left in the switch group SG2, the selection switch SS2, and the changeover switch CS2. As a result, the light receiving element group PG2 and the amplifier AMP1 are connected. In FIG. 13, the light receiving element 131 in communication included in the light receiving element group PG2 and the amplifier AMP1 used for the communication are indicated by hatching. A path between the light receiving element 131 in communication included in the light receiving element group PG2 and the amplifier AMP1 used for the communication is indicated by a thick line as a path through which a signal in communication with the first communication target propagates.

In the example of FIG. 13, the light receiving element group PG5 and the amplifier AMP3 are connected. The control circuit 17 closes the second switch SW from the left in the switch group SG5, the selection switch SS5, and the changeover switch CS7. As a result, the light receiving element group PG5 and the amplifier AMP3 are connected. In FIG. 13, the light receiving elements 131 in communication included in the light receiving element group PG5 and the amplifier AMP3 used for the communication are indicated by hatching. A path between the light receiving element 131 in communication included in the light receiving element group PG5 and the amplifier AMP3 used for the communication is indicated by a thick line as a path through which a signal in communication with the second communication target propagates.

Further, in the example of FIG. 13, the light receiving element group PG4 and the amplifier AMP2 are connected. The control circuit 17 closes the first switch SW from the left in the switch group SG4, the selection switch SS4, and the changeover switch CS5. As a result, the light receiving element group PG4 and the amplifier AMP2 are connected. In FIG. 13, the light receiving element 131 in communication included in the light receiving element group PG4 and the amplifier AMP2 used for the communication are indicated by hatching. A path between the light receiving element 131 in communication included in the light receiving element group PG4 and the amplifier AMP2 used for the communication is indicated by a thick line as a path through which a signal in communication with the third communication target propagates.

In the example of FIG. 13, three communication modes are set in parallel. In the communication mode, the control circuit 17 fixes connection between the light receiving element 131 and the amplifier AMP between which communication is established. According to the present control example, communication with three communication targets can be established. Communications with four or more communication targets may be set. In a case where the scanning mode and the communication mode are executed in parallel, it is sufficient if at least one amplifier AMP is set to be in an unused state so that scanning is performed.

### Control Example 5

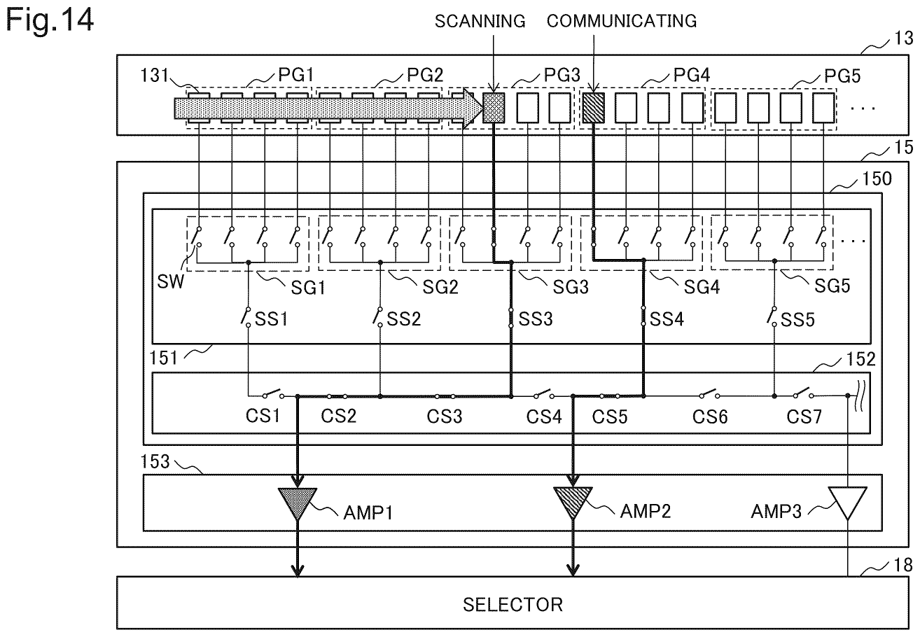

FIG. 14 is a conceptual view for explaining an example (Control Example 5) of the reception control for the spatial optical signal in the reception control device 14. The present control example is an example in which, after Control Example 4, communication with two communication targets (the first communication target and the second communication target) is finished, and new scanning is started while continuing communication with one communication target (the third communication target). In the example of FIG. 14, communication with one communication target (the third communication target) and scanning of a new communication target are performed in parallel.

In the example of FIG. 14, the light receiving element group PG4 and the amplifier AMP2 are connected. The control circuit 17 closes the first switch SW from the left in the switch group SG4, the selection switch SS4, and the changeover switch CS5. As a result, the light receiving element group PG4 and the amplifier AMP2 are connected. In FIG. 14, the light receiving elements 131 in communication included in the light receiving element group PG4 and the amplifier AMP2 used for the communication are indicated by hatching. A path between the light receiving element 131 in communication included in the light receiving element group PG4 and the amplifier AMP2 used for the communication is indicated by a thick line as a path through which a signal in communication with the third communication target propagates.

In the example of FIG. 14, the light receiving element group PG3 and the amplifier AMP1 are connected. The control circuit 17 closes the second switch SW from the left in the switch group SG3, the selection switch SS3, the changeover switch CS2, and the changeover switch CS3. As a result, the light receiving element group PG3 and the amplifier AMP1 are connected. In FIG. 14, the light receiving element 131 being scanned in the light receiving element group PG3 and the amplifier AMP1 used for the scanning are indicated by hatching. A path between the light receiving element 131 being scanned in the light receiving element group PG3 and the amplifier AMP1 used for the scanning is indicated by a thick line as a path through which a signal being scanned propagates.

In the example of FIG. 14, the communication mode and the scanning mode are set in parallel. In the communication mode, the control circuit 17 fixes connection between the light receiving element 131 and the amplifier AMP between which communication is established. As for the light receiving element group PG not used for communication, the control circuit 17 sequentially activates the light receiving elements 131 included in the light receiving element array 13 and selects the light receiving element 131 to be allocated to communication with the communication target. The control circuit 17 sets the scanning mode for the light receiving element groups PG other than the light receiving element group PG including the light receiving element 131 in communication. According to the present control example, the light receiving element 131 and the amplifier AMP used for communication can be diverted to scanning while continuing communication with a communication target for which communication is established.

### Modified Example 1

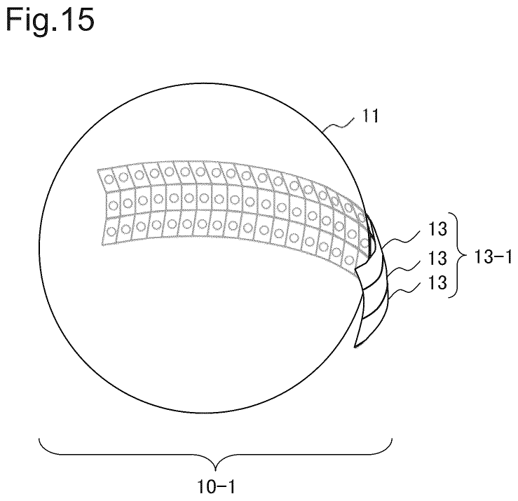

Next, Modified Example 1 according to the present example embodiment will be described with reference to the drawings. FIG. 15 is a conceptual view illustrating an example of a configuration of a light receiver 10-1 of the present modified example. FIG. 15 is a perspective view of the light receiver 10-1 viewed from a diagonally elevated perspective on an incident surface side. The light receiver 10-1 of the present modified example includes a ball lens 11 and a light receiving element array 13-1.

The light receiving element array 13-1 has a structure in which a plurality of light receiving element arrays 13 overlap each other in a short side direction. Each of the light receiving elements included in the light receiving element array 13-1 is arranged in a light collecting region of the ball lens 11. That is, the light receiving element array 13-1 includes a plurality of light receiving elements arranged in an array on a curved surface matching the light collecting region of the ball lens 11. FIG. 15 illustrates an example in which three light receiving element arrays 13 overlap each other to configure the light receiving element array 13-1, but the number of light receiving element arrays 13 included in the light receiving element array 13-1 is not particularly limited.

The light receiver 10-1 of the present modified example can similarly receive a spatial optical signal arriving at the ball lens 11 even when an arrival direction of the spatial optical signal is slightly shifted in the short side direction of the light receiving element array 13-1. In other words, according to the present modified example, even when the arrival direction of the spatial optical signal varies in a vertical direction in a plane formed by an arc of the light receiving element array 13-1, signal light derived from the spatial optical signal can be received by any one of the plurality of light receiving element arrays 13 included in the light receiving element array 13-1.

In a case where the arrival direction of the spatial optical signal is not limited to the same plane, when the spatial optical signal arriving from a three-dimensional direction with respect to the ball lens 11 cannot be received, a situation in which communication with a desired communication target cannot be performed may occur. According to the present modified example, the light receiving element array 13-1 in which the plurality of light receiving elements are arranged in an array is used, and thus, the light receiving range for the spatial optical signal can be expanded as compared with a case of using one light receiving element array 13.

### Modified Example 2

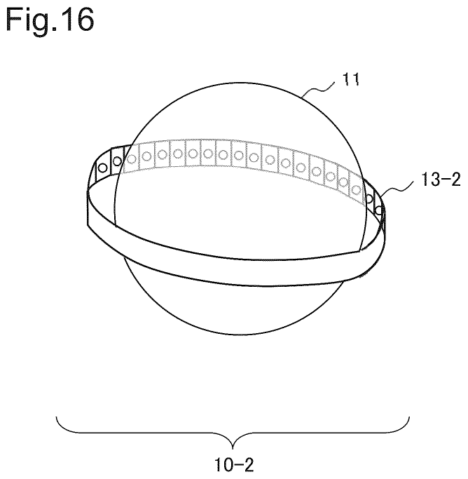

Next, Modified Example 2 according to the present example embodiment will be described with reference to the drawings. FIG. 16 is a conceptual view illustrating an example of a configuration of a light receiver 10-2 of the present modified example. FIG. 16 is a perspective view of the light receiver 10-2 viewed from a diagonally elevated perspective on an incident surface side. The light receiver 10-2 of the present modified example includes a ball lens 11 and a light receiving element array 13-2.

The light receiving element array 13-2 has a structure in which a plurality of light receiving element arrays 13 are connected in an annular shape. Each of light receiving elements included in the light receiving element array 13-2 is arranged in a light collecting region of the ball lens 11. That is, the light receiving element array 13-2 includes the plurality of light receiving elements arranged in an annular shape on a circumference matching the light collecting region of the ball lens 11. The number of light receiving elements included in the light receiving element array 13-2 is not limited. The light receiving element array 13-2 is arranged downstream of the ball lens 11. The plurality of light receiving elements each include a light receiving portion (not illustrated) that receives an optical signal derived from a spatial optical signal to be received. Each of the plurality of light receiving elements is arranged in such a way that an emission surface of the ball lens 11 faces the light receiving portion. Each of the plurality of light receiving elements is arranged in such a way that the light receiving portion is positioned in the light collecting region of the ball lens 11. The optical signal collected by the ball lens 11 is received by the light receiving portion of the light receiving element positioned in the light collecting region.

In a case where an arrival direction of the spatial optical signal is not limited to one direction, when the spatial optical signals arriving at the ball lens 11 from various directions cannot be received, there is a possibility that a situation in which communication with a desired communication target cannot be performed occurs. According to the present modified example, the light receiving element array 13-2 in which the plurality of light receiving elements are arranged in an annular shape is used, and thus, it is possible to receive the spatial optical signal arriving from a direction of 360 degrees.

### Comparative Example

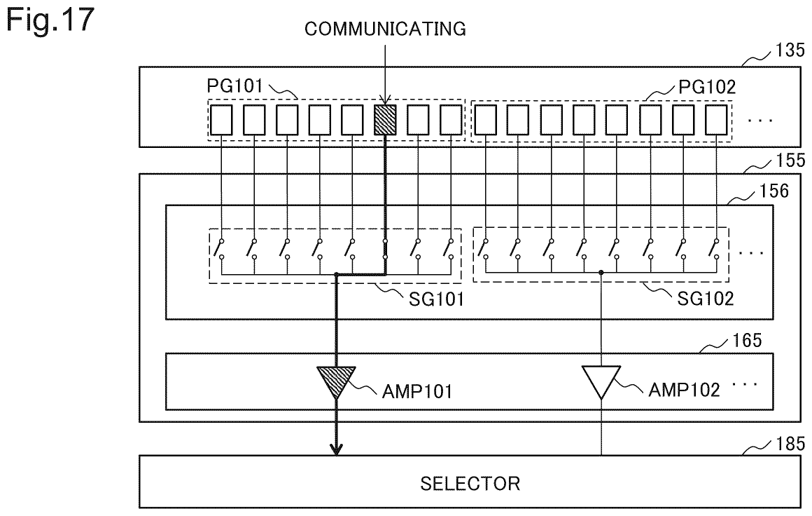

Next, light reception control according to a comparative example (related art) for the present example embodiment will be described with reference to the drawings. The comparative example has the problem to be solved by the present example embodiment. The comparative example is an example for explaining the problem that may occur when one amplifier is shared by a plurality of light receiving elements. FIG. 17 is a conceptual view for explaining light reception control of the comparative example. The light reception control of the comparative example will be described by taking a light reception device including a light receiving element array 135, a processing circuit 155, and a selector 185 as an example.

The light receiving element array 135 includes a plurality of light receiving elements. The plurality of light receiving elements included in the light receiving element array 135 is allocated to any one of a plurality of light receiving element groups PG (a light receiving element group PG101, a light receiving element group PG102, and the like).

The processing circuit 155 includes a switch group 156 including a plurality of switches and an amplifier circuit including a plurality of amplifiers AMP. Each of the plurality of switches included in the processing circuit 155 is connected to any one of the plurality of light receiving elements included in the light receiving element array 135. The plurality of switches included in the processing circuit 155 is allocated to any one of a plurality of switch groups SG (a switch group SG101, a switch group SG102, and the like).

Each of the plurality of amplifiers AMP (an amplifier AMP101 and an amplifier AMP102) included in the amplifier circuit 153 is arranged between the switch group 156 and the selector 185. The amplifier AMP101 is connected to output ends of the plurality of switches included in the switch group SG101. The amplifier AMP102 is connected to output ends of the plurality of switches included in the switch group SG102. An output end of each of the plurality of amplifiers AMP (the amplifier AMP101 and the amplifier AMP102) is connected to the selector 185.

In the example of FIG. 17, the sixth switch from the left in the switch group SG101 included in the switch group 156 is set to be closed. As a result, the sixth light receiving element from the left in the light receiving element group PG101 of the light receiving element array 135 is connected to the amplifier AMP101. A path between the light receiving element in communication included in the light receiving element group PG101 and the amplifier AMP101 used for the communication is indicated by a thick line as a path through which a signal being scanned propagates. In the comparative example, the light receiving element group PG101 including the light receiving element in communication and the amplifier AMP101 cannot be used for scanning. Therefore, the light receiving element group PG102 that does not include the light receiving element in communication and the amplifier AMP102 are used to scan another communication target. In the comparative example, since the switch group is not hierarchized and the amplifier AMP associated to the light receiving element group PG is fixed, switching the communication mode and the scanning mode cannot be flexibly made.

For example, it is assumed that, when every eight light receiving elements among 64 light receiving elements are allocated to each of eight amplifiers AMP, one amplifier AMP covers an angle of 15 degrees. Within the angle of 15 degrees, the width is 13.2 meters at a point 50 meters ahead, and is 26.3 meters at a point 100 meters ahead. With such a width, there is a possibility that two different communication targets enter a light receiving range of one amplifier AMP. When two different communication targets enter the light receiving range of one amplifier AMP, the spatial optical signals from the communication targets interfere with each other. In order to avoid interference from the same direction, it is necessary to leave an interval equivalent to two or three light receiving elements. That is, interference can be avoided by arranging one amplifier AMP for every three or four light receiving elements. However, 16 to 21 amplifiers AMP are required in a case where one amplifier AMP is arranged for every three or four light receiving elements. In addition, in order to accurately detect a direction of the communication target, it is necessary to configure a group including at least four light receiving elements. However, in a case of configuring the group including four light receiving elements, 64 light receiving elements are grouped into 16 groups, and thus, 16 amplifier circuits are required.

When one amplifier AMP is shared by a plurality of light receiving elements as in the comparative example, the number of circuits can be reduced. However, when any one of the parallelized light receiving elements is in use, the amplifier AMP associated with the light receiving element group including the light receiving element cannot be allocated to another scanning or communication. Therefore, many light receiving elements cannot be used. In the optical space communication, communication and scanning with a plurality of communication targets are performed in parallel, and it is thus difficult to implement continuous optical space communication with the configuration of Comparative Example 1. On the other hand, in the method of the present example embodiment, the number of amplifiers can be optimized while forming a group with an appropriate number of light receiving elements, and thus, the direction of the communication target can be accurately detected.

As described above, the light reception device of the present example embodiment includes a light receiving element array, a light collector (ball lens), and a reception control device. The light receiving element array includes a plurality of light receiving elements. The light collector collects a spatial optical signal toward at least one of the light receiving elements included in the light receiving element array. The reception control device includes a first processing circuit, a control circuit, a selector, and at least one second processing circuit. The first processing circuit includes a switching circuit and an amplifier circuit. The switching circuit includes a plurality of switches SW, a plurality of selection switches SS, and a plurality of changeover switches CS. Each of the plurality of switches SW is connected to each of the plurality of light receiving elements. The selection switch SS is arranged for each group (light receiving element group PG) to which the plurality of light receiving elements are distributed. The changeover switch CS switches an output destination of the selection switch SS for each group. The amplifier circuit includes a plurality of amplifiers AMP connected to outputs of the switching circuits. The selector is connected to an output of the first processing circuit. The second processing circuit is arranged downstream of the selector. The second processing circuit decodes a signal allocated via the selector. The control circuit controls the switching circuit in such a way as to allocate signals from the plurality of light receiving elements to one of the plurality of amplifiers AMP. The control circuit controls the selector in such a way as to allocate the signal amplified by the amplifier circuit to one of the second processing circuits.

With the communication control device of the present example embodiment, the number of amplifiers can be optimized while forming a group with an appropriate number of light receiving elements, and thus, continuous optical space communication can be implemented at a stable communication speed. In the present example embodiment, an example has been described in which the optical signal collected by the ball lens is received by the light receiving element array. The method of the present example embodiment can also be applied to reception of an optical signal collected by any light collector other than the ball lens.

In an aspect of the present example embodiment, output ends of the plurality of switches are integrated for each group. Input ends of the plurality of selection switches are connected to any of the output ends of the plurality of switches integrated for each group. Output ends of the plurality of selection switches are connected to a first end of at least one of the plurality of changeover switches. Second ends of the plurality of changeover switches are connected to an input end of any one of the plurality of amplifiers. The control circuit controls a connection state between the plurality of light receiving elements and the plurality of amplifiers by controlling opened/closed states of the switches, the selection switches, and the changeover switches included in the switching circuit. According to this aspect, the connection state between the plurality of light receiving elements and the plurality of amplifiers can be flexibly controlled by controlling the opened/closed states of the plurality of switches included in the switching circuit.

In an aspect of the present example embodiment, the control circuit sequentially switches the light receiving element connected to the amplifier used for scanning of a communication target by controlling the opened/closed states of the switches, the selection switches, and the changeover switches included in the switching circuit. The control circuit scans a spatial optical signal transmitted from the communication target by sequentially switching the light receiving element connected to the amplifier used for scanning the communication target. According to this aspect, the spatial optical signal transmitted from the communication target can be scanned by controlling the opened/closed states of the plurality of switches included in the switching circuit.

In an aspect of the present example embodiment, the control circuit closes the switch, the selection switch, and the changeover switch on a path between the light receiving element and the amplifier used for communication with at least one communication target to establish communication with the communication target. According to this aspect, communication with at least one communication target can be established by establishing a path between the light receiving element and the amplifier used for communication with at least one communication target.

In an aspect of the present example embodiment, the control circuit maintains the closed state of the switch, the selection switch, and the changeover switch on a path between the light receiving element and the amplifier used for communication with at least one communication target for which communication is established closed. The control circuit controls the switching circuit in such a way as to sequentially switch the light receiving element connected to the amplifier that is not used for communication, thereby scanning a spatial optical signal transmitted from a communication target different from the communication target in communication. According to this aspect, it is possible to scan another communication target while continuing communication with the communication target.

In an aspect of the present example embodiment, the plurality of light receiving elements included in the light receiving element array is allocated to any one of the groups including a number of light receiving elements that fall within a light receiving range in which the spatial optical signal transmitted from one communication target is received. According to this aspect, it is possible to configure a minimum number of amplifiers while grouping an appropriate number of light receiving elements for each communication target.

### Second Example Embodiment

Next, a communication device according to a second example embodiment will be described with reference to the drawings. The communication device of the present example embodiment has a configuration in which the light reception device of the first example embodiment and a light transmission device that transmits a spatial optical signal are combined. Hereinafter, an example of a communication device including a light transmission device including a phase-modulation-type spatial light modulator will be described. The communication device of the present example embodiment may include a transmission device having a light transmission function that is not a phase-modulation-type spatial light modulator.

### (Configuration)

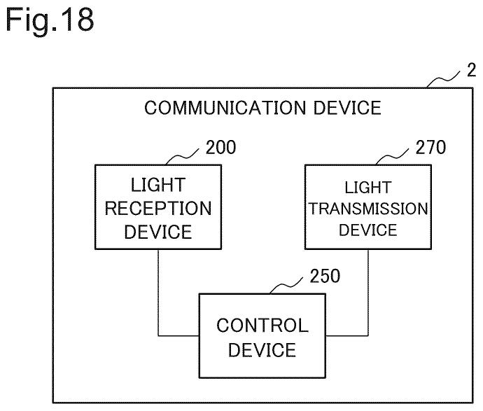

FIG. 18 is a conceptual view illustrating an example of a configuration of a communication device 2 according to the present example embodiment. The communication device 2 includes a light reception device 200, a control device 250, and a light transmission device 270. The light reception device 200 and the light transmission device 270 transmit and receive a spatial optical signal to and from an external communication target. Therefore, an opening or a window for transmitting and receiving a spatial optical signal is formed in the communication device 2.

The light reception device 200 is the light reception device of the first example embodiment. The light reception device 200 receives a spatial optical signal transmitted from a communication target (not illustrated). The light reception device 200 converts the received spatial optical signal into an electric signal. The light reception device 200 outputs the converted electric signal to the control device 250.

The control device 250 acquires a signal output from the light reception device 200. The control device 250 executes processing according to the acquired signal. The processing executed by the control device 250 is not particularly limited. The control device 250 outputs a control signal for transmitting an optical signal associated to the executed processing to the light transmission device 270.

The light transmission device 270 acquires a control signal from the control device 250. The light transmission device 270 projects a spatial optical signal relevant to the control signal. The spatial optical signal projected from the light transmission device 270 is received by the communication target (not illustrated). For example, the light transmission device 270 includes a phase-modulation-type spatial light modulator.

### [Transmission Device]

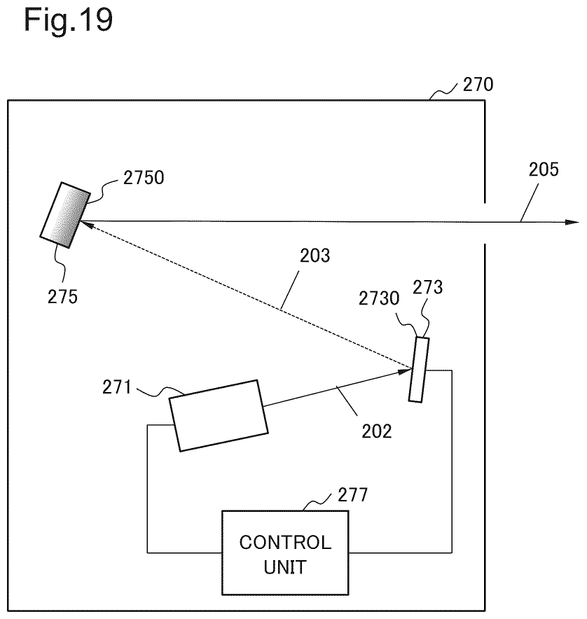

FIG. 19 is a conceptual view illustrating an example of a configuration of the light transmission device 270. The light transmission device 270 includes a light source 271, a spatial light modulator 273, a curved mirror 275, and a control unit 277. The light source 271, the spatial light modulator 273, and the curved mirror 275 are included in a transmission unit. FIG. 19 is a side view of an internal configuration of the light transmission device 270 as viewed from the lateral direction. FIG. 19 is a conceptual view and does not accurately represent a positional relationship between the components, a traveling direction of light, and the like.

The light source 271 emits laser light in a predetermined wavelength band under the control of the control unit 277. The wavelength of the laser light emitted from the light source 271 is not particularly limited and may be selected depending on the use. For example, the light source 271 emits laser light in a visible or infrared wavelength band. For example, in a case of a near-infrared ray of 800 to 900 nanometers (nm), since a laser class can be increased, sensitivity can be improved by about one digit as compared with other wavelength bands. For example, a high-output laser light source can be used for an infrared ray in a wavelength band of 1.55 micrometers (μm). As a laser light source of an infrared ray in a wavelength band of 1.55 μm, an aluminum gallium arsenide phosphide (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 271 includes a lens that expands laser light in accordance with a size of a modulation portion 2730 of the spatial light modulator 273. The light source 271 emits light 202 expanded by the lens. The light 202 emitted from the light source 271 travels toward the modulation portion 2730 of the spatial light modulator 273.

The spatial light modulator 273 includes the modulation portion 2730 irradiated with the light 202. The modulation portion 2730 of the spatial light modulator 273 is irradiated with the light 202 emitted from the light source 271. In the modulation portion 2730 of the spatial light modulator 273, a pattern (also referred to as a phase image) associated to an image displayed by projected light 205 is set under the control of the control unit 277. The light 202 incident on the modulation portion 2730 of the spatial light modulator 273 is modulated according to the pattern set in the modulation portion 2730 of the spatial light modulator 273. Modulated light 203 modulated by the modulation portion 2730 of the spatial light modulator 273 travels toward a reflection surface 2750 of the curved mirror 275.

For example, the spatial light modulator 273 is implemented by a spatial light modulator using ferroelectric liquid crystal, homogeneous liquid crystal, vertical alignment liquid crystal, or the like. For example, the spatial light modulator 273 can be implemented by liquid crystal on silicon (LCOS). The spatial light modulator 273 may be implemented by a micro electro mechanical system (MEMS). In the phase-modulation-type spatial light modulator 273, energy can be concentrated on the image by operating in such a way as to sequentially switch a portion on which the projected light 205 is to be projected. Therefore, in a case of using the phase-modulation-type spatial light modulator 273, if an output of the light source 271 is the same, the image can be displayed brighter as compared with those in a case of using other methods.

The modulation portion 2730 of the spatial light modulator 273 is divided into a plurality of regions (also referred to as tiling). For example, the modulation portion 2730 is divided into rectangular regions (also referred to as tiles) having a desired aspect ratio. The phase image is assigned to each of the plurality of tiles set in the modulation portion 2730. Each of the plurality of tiles includes a plurality of pixels. The phase image associated to the projected image is set for each of the plurality of tiles. The phase images set for the plurality of tiles may be the same or different.

The phase image is tiled for each of the plurality of tiles assigned to the modulation portion 2730. For example, a phase image generated in advance is set for each of the plurality of tiles. When the modulation portion 2730 is irradiated with the light 202 in a state where the phase images are set for the plurality of tiles, the modulated light 203 that forms an image associated to the phase image of each tile is emitted. As the number of tiles set in the modulation portion 2730 increases, a clear image can be displayed. However, when the number of pixels of each tile decreases, the resolution decreases. Therefore, the size and number of tiles set in the modulation portion 2730 are set depending on the use.

The curved mirror 275 is a reflecting mirror having the curved reflection surface 2750. The reflection surface 2750 of the curved mirror 275 has a curvature based on a projection angle of the projected light 205. The reflection surface 2750 of the curved mirror 275 is only required to be a curved surface. In the example of FIG. 31, the reflection surface 2750 of the curved mirror 275 has a shape of a side surface of a cylinder. For example, the reflection surface 2750 of the curved mirror 275 may be a spherical surface. For example, the reflection surface 2750 of the curved mirror 275 may be a free-form surface. For example, the reflection surface 2750 of the curved mirror 275 may have a shape in which a plurality of curved surfaces are combined, instead of a single curved surface. For example, the reflection surface 2750 of the curved mirror 275 may have a shape in which a curved surface and a flat surface are combined.

The curved mirror 275 is arranged on an optical path of the modulated light 203 with the reflection surface 2750 facing the modulation portion 2730 of the spatial light modulator 273. The reflection surface 2750 of the curved mirror 275 is irradiated with the modulated light 203 modulated by the modulation portion 2730 of the spatial light modulator 273. The light (projected light 205) reflected by the reflection surface 2750 of the curved mirror 275 is expanded at an expansion ratio based on the curvature of the reflection surface 2750 and projected. In the example of FIG. 31, the projected light 205 is expanded in a horizontal direction (a direction perpendicular to a plane of FIG. 31) according to a curvature of an irradiation range of the modulated light 203 on the reflection surface 2750 of the curved mirror 275. The curved mirror 275 may be omitted. In a case where the curved mirror 275 is omitted, the modulated light 203 modulated by the modulation portion 2730 of the spatial light modulator 273 may be directly projected as the projected light 205.

For example, a shield (not illustrated) may be arranged between the spatial light modulator 273 and the curved mirror 275. In other words, the shield may be arranged on an optical path of the modulated light 203 modulated by the modulation portion 2730 of the spatial light modulator 273. The shield is a frame that blocks unnecessary light components included in the modulated light 203 and defines an outer edge of a display region of the projected light 205. For example, the shield is an aperture in which a slit-shaped opening is formed at a portion through which light for forming a desired image passes. The shield passes light that forms a desired image and blocks unnecessary light components. For example, the shield blocks 0th-order light or a ghost image included in the modulated light 203. A detail description of the shield will be omitted.

The control unit 277 controls the light source 271 and the spatial light modulator 273. For example, the control unit 277 is implemented by a microcomputer including a processor and a memory. The control unit 277 sets a phase image associated to the projected image in the modulation portion 2730 according to the aspect ratio of tiling set in the modulation portion 2730 of the spatial light modulator 273. For example, the control unit 277 sets, in the modulation portion 2730, a phase image associated to an image for the use such as image display, communication, or distance measurement. The phase image of the projected image may be stored in advance in a storage unit (not illustrated). The shape and size of the projected image are not particularly limited.

The control unit 277 drives the spatial light modulator 273 in such a way that a parameter that determines a difference between a phase of the light 202 emitted to the modulation portion 2730 of the spatial light modulator 273 and a phase of the modulated light 203 reflected by the modulation portion 2730 changes. The parameter that determines the difference between the phase of the light 202 emitted to the modulation portion 2730 of the spatial light modulator 273 and the phase of the modulated light 203 reflected by the modulation portion 2730 is, for example, a parameter regarding optical characteristics such as a refractive index and an optical path length. For example, the control unit 277 adjusts the refractive index of the modulation portion 2730 by changing a voltage applied to the modulation portion 2730 of the spatial light modulator 273. A phase distribution of the light 202 emitted to the modulation portion 2730 of the phase-modulation-type spatial light modulator 273 is modulated according to the optical characteristics of the modulation portion 2730. A method for driving the spatial light modulator 273 by the control unit 277 is determined according to a modulation scheme of the spatial light modulator 273.

The control unit 277 drives the light source 271 in a state where the phase image associated to the image to be displayed is set in the modulation portion 2730. As a result, the light 202 emitted from the light source 271 is emitted to the modulation portion 2730 of the spatial light modulator 273 at a timing at which the phase image is set in the modulation portion 2730 of the spatial light modulator 273. The light 202 emitted to the modulation portion 2730 of the spatial light modulator 273 is modulated by the modulation portion 2730 of the spatial light modulator 273. The modulated light 203 modulated by the modulation portion 2730 of the spatial light modulator 273 is emitted toward the reflection surface 2750 of the curved mirror 275.

For example, the curvature of the reflection surface 2750 of the curved mirror 275 included in the light transmission device 270 and a distance between the spatial light modulator 273 and the curved mirror 275 are adjusted, and a projection angle of the projected light 205 is set to 180 degrees. By using two light transmission devices 270 configured as described above, the projection angle of the projected light 205 can be set to 360 degrees. If a part of the modulated light 203 is reflected by a plane mirror or the like inside the light transmission device 270 so that the projected light 205 is projected in two directions, the projection angle of the projected light 205 can be set to 360 degrees. For example, the light transmission device 270 configured to project the projected light in a direction of 360 degrees and the light receiver 10-2 (FIG. 16) of Modified Example 2 of the first example embodiment are combined. With such a configuration, it is possible to implement a communication device that transmits the spatial optical signal in a direction of 360 degrees and receives the spatial optical signal arriving from a direction of 360 degrees.

### Application Example 1

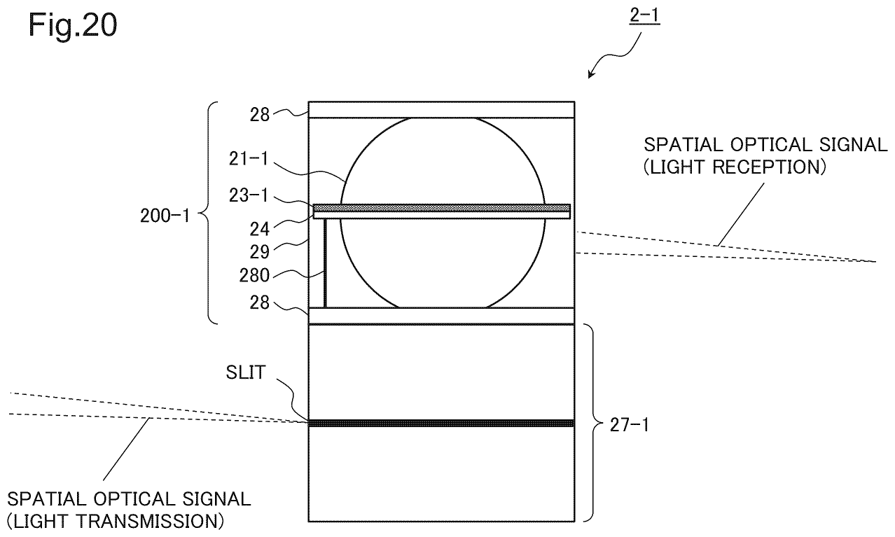

Next, Application Example 1 of the communication device 2 according to the present example embodiment will be described with reference to the drawings. FIG. 20 is a conceptual view for explaining a communication device 2-1 of the present application example. In the present application example, a communication network in which a plurality of communication devices 2-1 are arranged on poles such as utility poles or street lamps is configured.

FIG. 20 is a conceptual view illustrating an example of a configuration of the communication device 2-1. The communication device 2-1 includes a light reception device 200-1, a transmission device 27-1, and a control device (not illustrated). In FIG. 20, a light receiving circuit and the control device are omitted. The communication device 2-1 has a cylindrical outer shape. The light reception device 200-1 includes a ball lens 21-1, a light receiving unit 23-1, a substrate 24, a support element 28, and a color filter 29. The ball lens 21-1 is sandwiched between a pair of support elements 28 arranged above and below the ball lens 21-1. Upper and lower portions of the ball lens 21-1 are not used for transmitting and receiving a spatial optical signal, and thus may be formed to be flat in such a way as to be easily sandwiched by the support elements 28. The light receiving unit 23-1 is arranged in an annular shape in accordance with a light collecting region of the ball lens 21-1 in such a way as to be able to receive the spatial optical signal to be received. The light receiving unit 23-1 is formed on the substrate 24. The light receiving unit 23-1 is connected to the control device (not illustrated) and the transmission device 27-1 by a conductive wire 280. The color filter 29 is arranged on a side surface of the cylindrical light reception device 200-1. The color filter 29 removes unnecessary light and selectively transmits the spatial optical signal used for communication. The pair of support elements 28 are arranged on upper and lower surfaces of the cylindrical light reception device 200-1. The pair of support elements 28 sandwich the ball lens 21-1 from above and below. The light receiving unit 23-1 formed in an annular shape is arranged on an emission side of the ball lens 21-1. The spatial optical signal incident on the ball lens 21-1 through the color filter 29 is collected on the light receiving unit 23-1 by the ball lens 21-1. The control device (not illustrated) causes the transmission device 27-1 to transmit the spatial optical signal according to the optical signal received by the light receiving unit 23-1. For example, the transmission device 27-1 can be implemented by the configuration of FIG. 19. For example, the transmission device 27-1 may have a configuration in which a plurality of light sources, a spatial light modulator, a curved mirror, and a reflecting mirror are combined so that the spatial optical signal can be transmitted in a direction of 360 degrees. In the example of FIG. 20, the transmission device 27-1 has a slit formed in such a way that the spatial optical signal can be projected in a direction of 360 degrees.

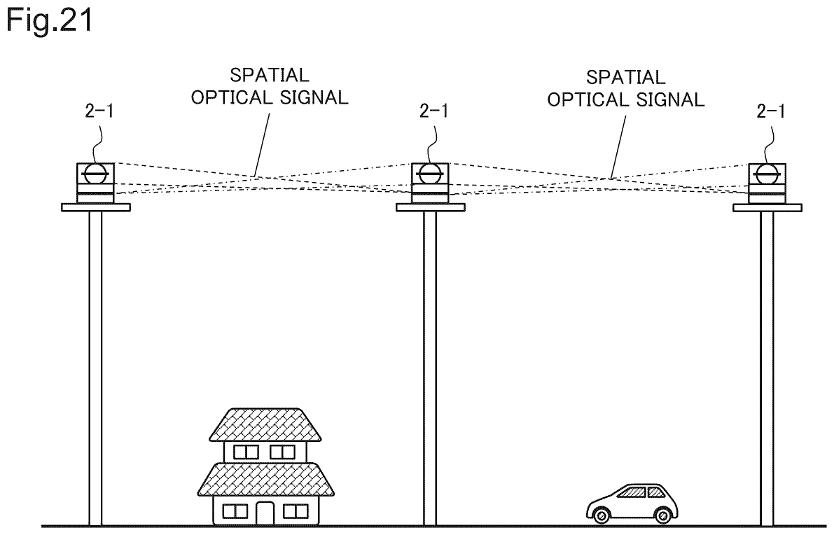

FIG. 21 illustrates an example in which a plurality of communication devices 2-1 arranged on utility poles form the communication network. The plurality of communication devices 2-1 mutually transmit and receive a spatial optical signal. There are few obstacles on an upper portion of a pole such as a utility pole or a street lamp. Therefore, the upper portion of the pole such as a utility pole or a street lamp is suitable for installing the communication device 2-1. In addition, in a case where the communication devices 2-1 are installed at the same height on the upper portions of the poles, the arrival direction of the spatial optical signal is limited to the horizontal direction, so that the light receiving area of the light receiving unit 23-1 included in the light reception device 200-1 can be reduced, and thus, device simplification can be achieved. A pair of communication devices 2-1 that perform communication with each other are arranged in such a way that at least one communication device 2-1 receives the spatial optical signal transmitted from the other communication device 2-1. The pair of communication devices 2-1 may be arranged to transmit and receive the spatial optical signal to and from each other. In a case where the communication network for the spatial optical signal includes the plurality of communication devices 2-1, it is sufficient if the communication device 2-1 positioned in the middle is arranged to relay the spatial optical signal transmitted from one communication device 2-1 to another communication device 2-1.

According to the present application example, communication using a spatial optical signal can be performed among the plurality of communication devices 2-1 installed on different poles. For example, wireless communication may be performed between a wireless device or a base station installed in an automobile, a house, or the like and the communication device 2-1 according to communication between the communication devices 2-1 installed on different poles. For example, the communication device 2-1 may be configured to be connected to the Internet via a communication cable or the like installed on the pole.

As described above, the communication device according to the present example embodiment includes a light reception device, a light transmission device, and a control device. The light transmission device transmits a spatial optical signal. The control device acquires a signal based on the spatial optical signal received by the light reception device. The control device executes processing according to the acquired signal. The control device causes the light transmission device to transmit the spatial optical signal associated to the executed processing. The light reception device includes a light receiving element array, a light collector (ball lens), and a reception control device. The light receiving element array includes a plurality of light receiving elements. The light collector collects a spatial optical signal toward at least one of the light receiving elements included in the light receiving element array. The reception control device includes a first processing circuit, a control circuit, a selector, and at least one second processing circuit. The first processing circuit includes a switching circuit and an amplifier circuit. The switching circuit includes a plurality of switches SW, a plurality of selection switches SS, and a plurality of changeover switches CS. Each of the plurality of switches SW is connected to each of the plurality of light receiving elements. The selection switch SS is arranged for each group (light receiving element group PG) to which the plurality of light receiving elements are distributed. The changeover switch CS switches an output destination of the selection switch SS for each group. The amplifier circuit includes a plurality of amplifiers AMP connected to outputs of the switching circuits. The selector is connected to an output of the first processing circuit. The second processing circuit is arranged downstream of the selector. The second processing circuit decodes a signal allocated via the selector. The control circuit controls the switching circuit in such a way as to allocate signals from the plurality of light receiving elements to one of the plurality of amplifiers AMP. The control circuit controls the selector in such a way as to allocate the signal amplified by the amplifier circuit to one of the second processing circuits.

With the communication control device of the present example embodiment, the number of amplifiers can be optimized while forming a group with an appropriate number of light receiving elements, and thus, continuous optical space communication can be implemented at a stable communication speed.

### Third Example Embodiment

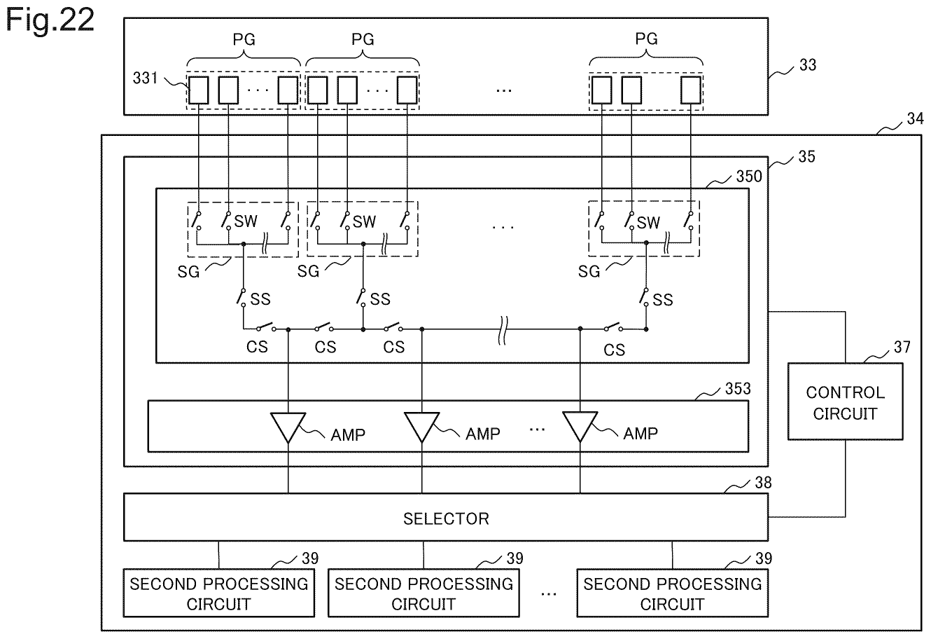

Next, a communication control device according to a third example embodiment will be described with reference to the drawings. The communication control device of the present example embodiment has a configuration in which the communication control device of the first example embodiment is simplified. FIG. 22 is a conceptual view illustrating an example of a configuration of a communication control device 34 of the present example embodiment. The communication control device 34 includes a first processing circuit 35, a control circuit 37, a selector 38, and at least one second processing circuit 39. FIG. 22 also illustrates a light receiving element array 33 connected to the communication control device 34. The light receiving element array includes a plurality of light receiving elements 331.

The first processing circuit 35 includes a switching circuit 350 and an amplifier circuit 353. The switching circuit 350 includes a plurality of switches SW, a plurality of selection switches SS, and a plurality of changeover switches CS. Each of the plurality of switches SW is connected to each of the plurality of light receiving elements 131. The selection switch SS is arranged for each group (light receiving element group PG) to which the plurality of light receiving elements 131 are distributed. The changeover switch CS switches an output destination of the selection switch SS for each group. The amplifier circuit 353 includes a plurality of amplifiers AMP connected to outputs of the switching circuits 350. The selector 38 is connected to an output of the first processing circuit 35. The second processing circuit 39 is arranged downstream of the selector 38. The second processing circuit 39 decodes a signal allocated via the selector 38. The control circuit 37 controls the switching circuit 350 in such a way as to allocate signals from the plurality of light receiving elements 131 to one of the plurality of amplifiers AMP. The control circuit 37 controls the selector 38 in such a way as to allocate the signal amplified by the amplifier circuit 353 to one of the second processing circuits 39.

As described above, with the communication control device of the present example embodiment, the number of amplifiers can be optimized while forming a group with an appropriate number of light receiving elements, and thus, continuous optical space communication can be implemented at a stable communication speed.

### (Hardware)

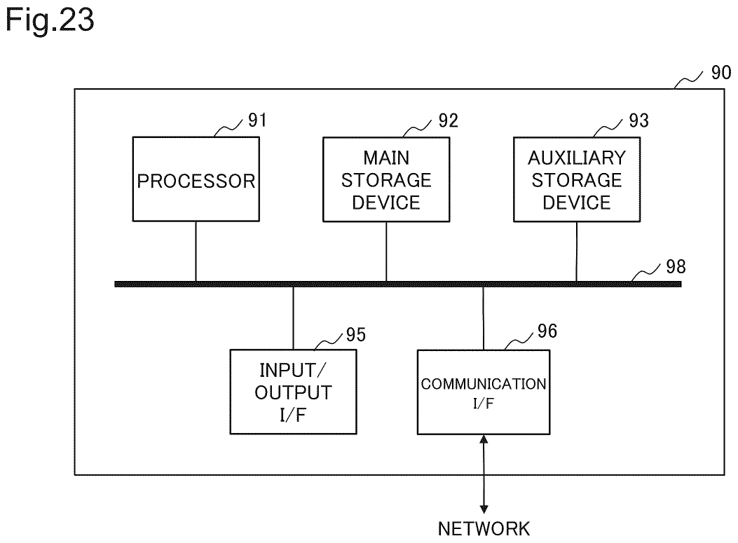

Here, a hardware configuration for executing control and processing according to each example embodiment of the present disclosure will be described using an information processing device 90 in FIG. 23 as an example. The information processing device 90 in FIG. 23 is a configuration example for executing the control and processing according to each example embodiment, and does not limit the scope of the present disclosure.

As illustrated in FIG. 23, the information processing device 90 includes a processor 91, a main storage device 92, an auxiliary storage device 93, an input/output interface 95, and a communication interface 96. In FIG. 23, the interface is abbreviated as an I/F. The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 loads a program stored in the auxiliary storage device 93 or the like to the main storage device 92. The processor 91 executes the program loaded to the main storage device 92. In the present example embodiment, it is sufficient if a software program installed in the information processing device 90 is used. The processor 91 executes the control and processing according to the present example embodiment.

The main storage device 92 has a region to which the program is loaded. A program stored in the auxiliary storage device 93 or the like is loaded to the main storage device 92 by the processor 91. The main storage device 92 may be implemented by a volatile memory such as a dynamic random access memory (DRAM). A nonvolatile memory such as a magneto resistive random access memory (MRAM) may be configured and added as the main storage device 92.

The auxiliary storage device 93 stores various pieces of data such as programs. The auxiliary storage device 93 is implemented by a local disk such as a hard disk or a flash memory. Various pieces of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a protocol or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. In a case where the touch panel is used as the input device, a display screen of a display device may also serve as the interface of the input device. Data communication between the processor 91 and the input device may be performed via the input/output interface 95.

The information processing device 90 may be provided with a display device for displaying information. In a case where the display device is provided, the information processing device 90 preferably includes a display control device (not illustrated) for controlling display of the display device. The display device may be connected to the information processing device 90 via the input/output interface 95.

Further, the information processing device 90 may be provided with a drive device. The drive device mediates, for example, reading of data and a program from a recording medium and writing of a processing result of the information processing device 90 to the recording medium between the processor 91 and the recording medium (program recording medium). The drive device may be connected to the information processing device 90 via the input/output interface 95.

An example of the hardware configuration for executing the control and processing according to each example embodiment of the present invention has been described above. The hardware configuration in FIG. 23 is an example of the hardware configuration for executing the control and processing according to each example embodiment, and does not limit the scope of the present invention. In addition, a program for causing a computer to execute the control and processing according to each example embodiment also falls within the scope of the present invention. Further, a program recording medium having the program according to each example embodiment recorded therein also falls within the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. Furthermore, the recording medium may be implemented by a magnetic recording medium such as a flexible disk, or another recording medium. In a case where the program executed by the processor is recorded in a recording medium, the recording medium corresponds to the program recording medium.

Any combination of the components of each example embodiment is possible. In addition, the components of each example embodiment may be implemented by software or may be implemented by a circuit.

While the present invention has been particularly shown and described with reference to the example embodiments thereof, the present invention is not limited to these example embodiments. It will be understood by those of ordinary skill in the art that various changes in form and details may be made therein without departing from the spirit and scope of the present invention as defined by the claims.

### REFERENCE SIGNS LIST

2 Communication device
10 Light reception device
11 Ball lens
13 Light receiving element array
14 Reception control device
15 First processing circuit
17 Control circuit
18 Selector
19 Second processing circuit
100 Light receiver
130 Substrate
131 Light receiving element
150 Switching circuit
151 First switch circuit
152 Second switch circuit
153 Amplifier circuit
200 Light reception device
250 Control device
270 Light transmission device
271 Light source
273 Spatial light modulator
275 Curved mirror

What is claimed is:

1. A reception control device comprising:
a first processing circuit that includes a switching circuit including a switch connected to each of a plurality of light receiving elements, a selection switch arranged for each group to which the plurality of light receiving elements are distributed, and a changeover switch that switches an output destination of the selection switch for each group, and an amplifier circuit including a plurality of amplifiers connected to an output of the switching circuit;
a selector that is connected to an output of the first processing circuit;
at least one second processing circuit that is arranged downstream of the selector and decodes a signal allocated via the selector; and
a control circuit comprising a first memory storing instructions, and a first processor connected to the first memory and configured to execute the instructions to
control the switching circuit to allocate a signal from each of the plurality of light receiving elements to any one of the plurality of amplifiers, and
control the selector to allocate the signal amplified by the amplifier circuit to any one of the second processing circuits.

2. The reception control device according to claim 1, wherein
output ends of a plurality of the switches are integrated for each group,
an input end of each of a plurality of the selection switches is connected to any one of the output ends of the plurality of switches integrated for each group,
an output end of each of the plurality of selection switches is connected to a first end of at least one of the plurality of changeover switches,
a second end of each of the plurality of changeover switches is connected to an input end of any one of the plurality of amplifiers, and
the first processor of the control circuit is configured to execute the instructions to control a connection state between the plurality of light receiving elements and the plurality of amplifiers by controlling opened/closed states of the switch, the selection switch, and the changeover switch included in the switching circuit.

3. The reception control device according to claim 2, wherein
the first processor of the control circuit is configured to execute the instructions to sequentially switch the light receiving element connected to the amplifier used for scanning a communication target by controlling the opened/closed states of the switch, the selection switch, and the changeover switch included in the switching circuit to scan a spatial optical signal transmitted from the communication target.

4. The reception control device according to claim 3, wherein
the first processor of the control circuit is configured to execute the instructions to close the switch, the selection switch, and the changeover switch on a path between the light receiving element and the amplifier used for communication with at least one communication target to establish communication with the communication target.

5. The reception control device according to claim 4, wherein
the first processor of the control circuit is configured to execute the instructions to control the switching circuit to sequentially switch the light receiving element connected to the amplifier that is not used for communication while maintaining the closed state of the switch, the selection switch, and the changeover switch on a path between the light receiving element and the amplifier used for communication with at least one communication target for which communication is established, to scan a spatial optical signal transmitted from a communication target different from the communication target in communication.

6. A light reception device comprising:
the reception control device according to claim 1;
a light receiving element array including a plurality of light receiving elements; and
a light collector that collects a spatial optical signal toward at least one of the light receiving elements included in the light receiving element array.

7. The light reception device according to claim 6, wherein
the plurality of light receiving elements included in the light receiving element array are allocated to any one of groups including a number of the light receiving elements that fall within a light receiving range in which the spatial optical signal transmitted from one communication target is received.

8. A communication device comprising:
the light reception device according to claim 6;
a light transmission device that transmits a spatial optical signal; and
a controller comprising a second memory storing instructions, and a second processor connected to the second memory and configured to execute the instructions to
acquire a signal based on a spatial optical signal received by the light reception device,
execute processing according to the acquired signal, and
cause the light transmission device to transmit a spatial optical signal associated to the executed processing.

9. A reception control method comprising by a control circuit:
controlling a first processing circuit including a switching circuit that includes a first switch circuit including a switch connected to each of a plurality of light receiving elements and a second switch circuit switching an output destination of each group in which some of a plurality of the switches included in the first switch circuit are integrated, and an amplifier circuit including a plurality of amplifiers connected to an output of the switching circuit, to allocate a signal from each of the plurality of light receiving elements to any one of the plurality of amplifiers connected to the output of the switching circuit; and
controlling a selector connected to outputs of the plurality of amplifiers to allocate the signal amplified by the amplifier circuit to any one of a plurality of second processing circuits that decode the signal output from the first processing circuit.

10. A non-transitory recording medium recording a program that causes a computer to execute processing of:
controlling a first processing circuit including a switching circuit that includes a first switch circuit including a switch connected to each of a plurality of light receiving elements and a second switch circuit switching an output destination of each group in which some of a plurality of the switches included in the first switch circuit are integrated, and an amplifier circuit including a plurality of amplifiers connected to an output of the switching circuit, to allocate a signal from each of the plurality of light receiving elements to any one of the plurality of amplifiers connected to the output of the switching circuit; and
controlling a selector connected to outputs of the plurality of amplifiers to allocate the signal amplified by the amplifier circuit to any one of a plurality of second processing circuits that decode the signal output from the first processing circuit.
